(19) United States
(12) Patent Application Publication
(10) Pub. No.: US 2024/0226839 A1
(43) Pub. Date: Jul. 11, 2024

(54) SYSTEM AND PROCESS FOR RECLAIMING A METAL-CONTAINING SALT SOLUTION FROM A LITHIUM-CONTAINING BATTERY MATERIAL, AND CHEMICALS THEREOF

(71) Applicant: eJoule, Inc., Fremont, CA (US)

(72) Inventors: L. Bin Chen, Bethany, CT (US); Min Duan Liu, Bethany, CT (US); Liang-Yuh Chen, Saratoga, CA (US)

(21) Appl. No.: 18/611,342

(22) Filed: Mar. 20, 2024

Related U.S. Application Data
(63) Continuation-in-part of application No. 17/970,342, filed on Oct. 20, 2022.
Application No. 17/970,342 is a continuation of application No. 16/104,841, filed on Aug. 17, 2018, now Pat. No. 11,511,251.
Application No. 16/104,841 is a continuation of application No. 13/901,035, filed on May 23, 2013, now Pat. No. 10,086,351.
(60) Provisional application No. 61/855,063, filed on May 6, 2013.

(51) Int. Cl. B01J 8/18; B01J 8/24; B01J 12/02; B22F 9/08; B22F 9/22; C01B 13/14; C01B 13/34; C01B 25/45; C01G 1/02; H01M 4/04; H01M 4/36; H01M 4/505; H01M 4/525

(52) U.S. Cl. CPC B01J 8/18; B01J 8/1827; B01J 8/24; B01J 12/02; B22F 9/082; B22F 9/22; C01B 13/14; C01B 13/34; C01B 25/45; C01G 1/02; H01M 4/04; H01M 4/0471; H01M 4/36; C01P 2006/40; H01M 4/505; H01M 4/525; Y02P 20/129; Y02P 20/145

(57) ABSTRACT

A system and process for recovering a metal containing organic and/or inorganic salt solution from a lithium-containing battery material, and chemicals thereof is disclosed. The process includes leaching the lithium-containing battery material in a leaching solution comprising water and sulfuric acid (H₂SO₄) to obtain a leachate solution, adding metal hydroxide (Me(OH)ₓ) to the leachate solution, titrating the leachate solution with an aqueous acid solution to maintain the leachate solution to be at a pH 7.0 or less and obtaining a precipitate comprising metal sulfate (Me_{y}SO₄), and separating solid forms of metal sulfate (Me_{y}SO₄) from the leachate solution and acquiring the metal-containing organic and/or inorganic salt solution that can be reused in batteries in a battery manufacturing process

### CROSS-REFERENCE TO RELATED APPLICATIONS

This application is a continuation-in-part application of co-pending U.S. patent application Ser. No. 17/970,342, filed Oct. 20, 2022, which is a continuation of U.S. patent application Ser. No. 16/104,841, filed on Aug. 17, 2018, which is a continuation of U.S. patent application Ser. No. 13/901,035, filed on May 23, 2013, which claims benefit of U.S. provisional patent application Ser. No. 61/855,063, filed on May 6, 2013. All of the above-referenced applications are herein incorporated by reference.

### FIELD OF THE INVENTION

This invention generally relates to system and process for recovering valuable metal-containing organic and/or inorganic salt solution from a lithium-containing battery material, and the chemicals thereof.

### BACKGROUND OF THE INVENTION

Great efforts have been devoted to the development of advanced electrochemical battery cells to meet the growing demand of various consumer electronics, electrical vehicles, and grid energy storage applications in terms of high energy density, high power performance, high capacity, long cycle life, low cost and excellent safety. In most case, it is desirable for a battery to be miniaturized, light-weighted and rechargeable (thus reusable) to save space and material resources.

In the past two decades, the automobile market has witnessed a blooming of developments of Electric Vehicles (EVs). The rapid growth of the EVs' market share let many experts believe that we have passed the tipping point where the manufacturing and selling of EVs will start to catch up with traditional gasoline vehicles. The International Energy Agency predicts that, by 2030, the number of electric vehicles worldwide will increase to 125 million. On a more ambitious prediction, the number could even go up to 220 million. This is a result based on the assumption that electric vehicles could reach 30% of the total car market.

This rapid growth leads to a high demand of batteries that have higher energy density and larger capacity. Lithium ion battery is a secondary battery which was developed in the early 1990s. As compared to other secondary batteries, it has the advantages of high energy density, long cycle life, no memory effect, low self-discharge rate and environmentally benign. Lithium ion battery rapidly gained acceptance and dominated the commercial secondary battery market. However, the cost for commercially manufacturing various lithium battery materials is considerably higher than other types of secondary batteries.

Currently, Lithium Ion Battery (LIB) is among the most popular types of secondary batteries used in all sorts of batteries, including phones, laptops, and, of course, electric cars. Lithium (Li), Nickel (Ni), Cobalt (Co), Aluminum (Al), and Manganese (Mn) are the main metal components in Lithium-Ion Batteries.

With more and more companies starting to produce electric vehicles, the price of these raw materials also goes up in a skyrocketing fashion. Specifically, the prices of cobalt and lithium have risen sharply by 29% and 129% respectively worldwide.

Therefore, while seeking a lower price for these raw materials would be a direct solution to mitigate the problem of high prices, another way to lower production cost is through recovering wasted or unused raw materials. Specifically, there are two main sources for recovery: waste batteries and waste materials during manufacturing process. Currently, the recycling rate of lithium-ion batteries is “still low at under 5%.” This is a direct result of the cost and complexity of the current recycling method.

Battery recycling's value rests mostly in the recovery of cathode materials, which contain the metal suggested above (Li, Ni, Co, Al and Mn). There are two methods most commonly used in the recovery process: pyrometallurgy and hydrometallurgy. Pyrometallurgy is a thermal treatment process to recover valuable metals and bring about the physical and chemical transformation of battery materials, by heating the mineral materials under extremely high temperatures (1,400° C. or higher) to produce the desired end product. This process is dominating in the industry because it is simple and straightforward. However, burning minerals under such a high temperature is dangerous to the operators, and the high energy consumption during the heating and large emissions of harmful fumes also make it a procedure that requires high regulation, which further raises the administrative cost.

Alternatively, hydrometallurgy is used to recover valuable metals from the batteries cathode materials through physical and chemical processes. It is a more desirable option due to its low energy consumption, more straightforward procedures, and high yields. Initially, battery materials are dissolved using N-Methylpyrrolidone (NMP), ultrasonic treatment, and/or alkaline leaching. Next, after going through the process of dissociation, leaching, separation and purification, such as using solvent extraction, ion exchange, selective precipitation, etc., battery metal oxide materials are reduced to metals or compounds, and recovered. In a waste battery, dissociation of materials and separation of target metal materials from other materials are first performed. The common dissociation technology is crushing and grinding, basically grinding the waste portion into particles. The finer the particles, the better the quality for the following step, leaching.

Current available processes focus on recovering solid metals. Thus, there is a need to recover and reclaim various valuable metals in ionic or solution forms from battery related materials.

### SUMMARY OF THE INVENTION

This invention generally relates to system and process for recovering and reclaiming a metal-containing organic and/or inorganic salt solution from a lithium-containing battery material, and chemicals thereof. Specifically, this invention seeks to reclaim valuable metal ions from batteries and battery materials, keep them in ionic and/or solution forms, so it could be reused in the battery material production line without further processing. In one embodiment, a method for recovering and reclaiming a metal-containing organic and/or inorganic salt solution from a lithium-containing battery material is provided and includes leaching the lithium-containing battery material by adding the lithium-containing battery material into a leaching solution comprising water and sulfuric acid (H₂SO₄) to obtain a leachate solution, adding metal hydroxide (Me(OH)ₓ) to the leachate solution, titrating the leachate solution with an aqueous acid solution to maintain the leachate solution to be at a pH 7.0 or less and obtaining a precipitate comprising metal sulfate (Me_{y}SO₄), and separating solid forms of metal sulfate (Me_{y}SO₄) from the leachate solution and acquiring the metal-containing organic and/or inorganic salt solution.

In another embodiment, a processing system for recovering and reclaiming a metal-containing organic and/or inorganic salt solution from a lithium-containing battery material includes a first reaction chamber having a liquid mixer and a chamber outlet, a first gas-solid separator having a first separator outlet and a second separator outlet, a second reaction chamber connected to a product collector, and one or more recovering apparatuses. In one aspect, each recovering apparatus includes at least one collector to collect solids of the lithium-containing battery material from the processing system, and at least one leaching container connected to at least one collector, where the at least one leaching container contains therein a leaching solution comprising water and sulfuric acid (H₂SO₄). In another aspect, the at least one collector is connected to an outlet within the processing system, and the outlet may be the chamber outlet, the first separator outlet, the second separator outlet, the product collector, and/or combinations thereof.

In still another embodiment, a processing system is provided and includes a first reaction chamber having a liquid mixer and a chamber outlet, a first gas-solid separator having a first separator outlet and a second separator outlet, a second reaction chamber connected to a product collector, a second gas-solid separator having a third separator outlet and a fourth separator outlet, and one or more recovering apparatuses. Each recovering apparatus includes at least one collector to collect solids of the lithium-containing battery material from the processing system, and at least one leaching container connected to at least one collector, where the at least one leaching container contains therein a leaching solution comprising water and sulfuric acid (H₂SO₄). In addition, the at least one collector is connected to an outlet within the processing system, and the outlet may be the chamber outlet, the product collector, the first separator outlet, the second separator outlet, the third separator outlet, the fourth separator outlet, and/or combinations thereof.

In yet another embodiment, a metal-containing organic and/or inorganic salt solution, is provided and includes a processed leachate solution obtained after a process of leaching by a leaching solution comprising a lithium-containing battery material, sulfuric acid (H₂SO₄), and water, adding metal hydroxide (Me(OH)ₓ) to the leachate solution; titrating the leachate solution with an organic acid compound to maintain the leachate solution to be at a pH 7.0 or less, and obtaining a precipitate comprising metal sulfate (Me_{y}SO₄) and removing solid forms of metal sulfate (Me_{y}SO₄) from the leachate solution to acquire, recover and reclaim the metal-containing organic and/or inorganic salt solution.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an embodiment of a process of recovering a metal-containing organic and/or inorganic salt solution from a lithium-containing battery material.

FIG. 2 is a schematic of an exemplary processing system.

FIG. 3A is a portion of an exemplary schematic of apparatus and process flow to be used in recovering a metal containing organic and/or inorganic salt solution from a lithium-containing battery material.

FIG. 3B is another portion of the exemplary apparatus and process flow in FIGS. 2 and 1 according to one or more embodiments of the invention.

FIG. 3C is yet another portion of the exemplary apparatus and process flow in FIGS. 2 and 1 according to one or more embodiments of the invention.

### DETAILED DESCRIPTION

This invention generally relates to a method, processing system, and a metal-containing organic and/or inorganic salt solution produced thereof. The system is provided for recovering and reclaiming valuable lithium-ion battery materials during battery material manufacturing process. The method includes the use of sulfuric acid in a hydrometallurgical leaching solution to extract metals from batteries and metal-containing battery materials. Also, metal hydroxide (Me(OH)ₓ) is added to the leaching solution to form a leachate solution and keep valuable metals in an ionic form in the leachate solution. The leachate solution can then be used directly in the cathode material manufacturing process, or it can also be further processed to separate each one of the metal ions thereof. Specifically, the goal is to reclaim active metal substances, in ionic or solution form, from a battery material manufacturing process. The targeted metal-containing materials include, but are not limited to, Lithium (Li), Nickel (Ni), Cobalt (Co), Aluminum (Al), Magnesium (Mg), Manganese (Mn), other metals found in batteries, and combinations thereof. This invention provides a hydrometallurgical recovery process that enables high metal recovery of battery materials in a high metal purity manner.

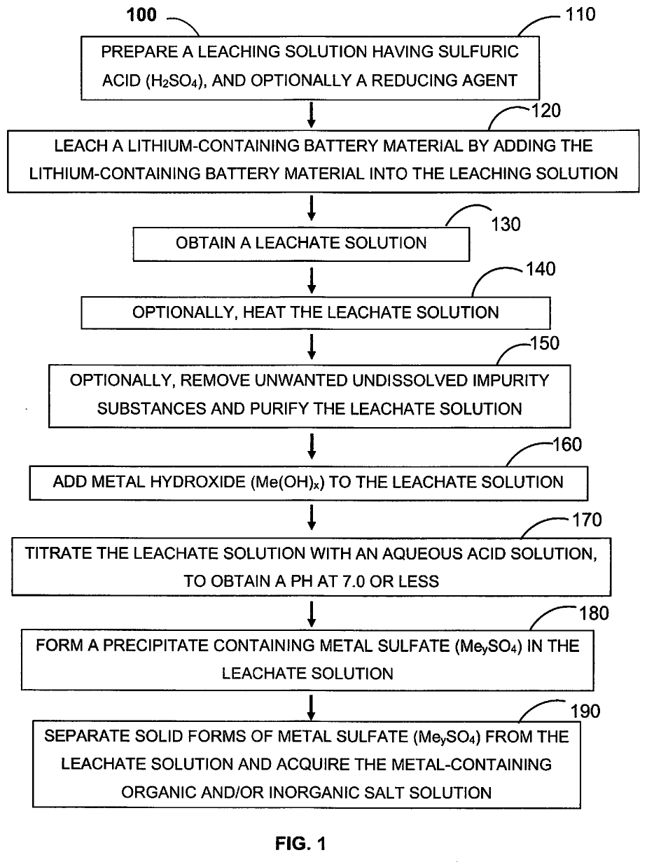

FIG. 1 is a flow chart of a method 100 to recover a metal-containing organic and/or inorganic salt solution from a lithium-containing battery material. The method 100 includes step 110 of preparing a leaching solution, which includes sulfuric water and sulfuric acid (H₂SO₄). The sulfuric acid leaching solution may be prepared at a concentration of more than 0.1M, such as more than 0.15M, such as more than 0.2M, such as more than 0.25M, such as more than 0.3M, such as more than 0.35M, such as more than 0.4M, such as more than 0.45 M, such as more than 0.5M, such as more than 0.55M, such as more than 0.6M, such as more than 0.65M, such as more than 0.7M, such as more than 0.75M, such as more than 0.8M, such as more than 0.85M, such as more than 0.9M, such as more than 0.95M, such as more than 0.99M. Here, the sulfuric acid (H₂SO₄) is a concentrated acid that can be used as a highly reactive agent to oxidize, dehydrate, sulfonate, release heat and/or dissolve metals within the lithium-containing battery material.

The leaching solution may also include a reducing agent. Exemplary reducing agent includes organic and/or inorganic reducing agents, hydrogen peroxide (H₂O₂), sodium hydrogen sulfite (sodium bisulfite, NaHSO₃), glucose (C₆H₁₂O₆), sucrose (C₁₂H₂₂O₁₁), hydrogen gas (H₂), sodium borohydride (NaBH₄), hydrazine (N₂H₄), formic acid (HCOOH), sodium metabisulfite (Na₂S₂O₅), ferrous sulfate (FeSO₄), hypophosphite salts, salts such as sodium hypophosphite (NaH₂PO₂), dithionite salts such as sodium dithionite (Na₂S₂O₄), carbon monoxide (CO), electric current, microorganisms for bioleaching, and combinations thereof, among others. The reducing agent in the leaching solution may be added into a final concentration of more than 0.1M, such as 0.1M or more, such as 0.15M or more, such as 0.2M, such as 0.25M or more, such as 0.3M or more, such as 0.35M or more, such as 0.4M or more, such as 0.45M or more, such as 0.5M or more, such as 0.55M or more, such as 0.6M or more, such as 0.65M or more, such as 0.7M or more, such as 0.75M or more, such as 0.8M or more, such as 0.85M or more, such as 0.9M or more, such as 0.95M or more, such as 0.99M or more. Here, the reducing agent can be used to contribute electrons during a chemical reaction and speed up the reaction time.

At step 120, the lithium-containing battery material is added to the leaching solution and a leachate solution is obtained at step 130. Accordingly, the solid form of the lithium-containing battery material is dissolved in the leachate solution, which comprises sulfuric acid (H₂SO₄), and optionally, one or more reducing agents.

In one embodiment, the lithium-containing battery material includes but is not limited to anode materials. Exemplary anode materials include but are not limited to alkali metals (such as lithium, sodium, potassium, etc.), other metals or transition metals (such as tantalum, titanium zinc, iron, the elements on the Group 2 of the periodic table (e.g., magnesium, calcium, etc.)), the elements on Group 13 and Group 14 of the periodic table (such as aluminum (Al), germanium (Ge), etc.), a carbonaceous material, and/or metal alloys of two or more of the aforementioned metals. Exemplary anode materials further include but are not limited to lithium metal, lithium alloys (e.g., lithium-aluminum alloys, lithium-tin alloys, lithium-lead alloys, and lithium-silicon alloys), lithium-containing metal oxides (e.g. lithium titanium oxide), lithium-containing metal sulfides, lithium-containing metal nitrides (e.g. lithium cobalt nitride, lithium iron nitride, lithium manganese nitride), and carbonaceous materials such as graphite, carbon-based materials such as lithium titanate (Li₄Ti₅O₁₂), SiO-based composites, SiO—Sn—Co/graphite (G) composites, Si, Sn—Co—C mixed composites, and lithium coated with a solid electrolyte.

In another embodiment, the lithium-containing battery material collected from at least one collector (e.g., 314A, 314B, 314C, 314D, 314E, 314F) includes but is not limited to cathode active materials. Exemplary cathode active materials include but are not limited to mixed metal oxides, a metal oxide with two or more metals (MeₓMe′_{y}O_{z}), a metal oxide with three or four intercalated metals, lithium transitional metal oxide (LiMeO₂), lithium titanium oxide (e.g., Li₄Ti₅O₁₂), lithium cobalt oxide (e.g., LiCoO₂), lithium manganese oxide (e.g., LiMn₂O₄), lithium nickel oxide (e.g., LiNiO₂), lithium iron phosphate (e.g., LiFePO₄), lithium cobalt phosphate (e.g., LiCoPO₄), lithium manganese phosphate (e.g., LiMnPO₄), lithium nickel phosphate (e.g., LiNiPO₄), sodium iron oxide (e.g., NaFe₂O₃), sodium iron phosphate (e.g., NaFeP₂O₇), lithium nickel manganese cobalt oxide (LiNiₓMn_{y}Co_{z}O₂), lithium nickel cobalt aluminum oxide (NCA), lithium nickel cobalt manganese aluminum oxide, lithium nickel manganese cobalt oxide, lithium nickel magnesium cobalt oxide, lithium lanthanum zirconium oxide (LLZO, solid state lithium-stuffed garnet material), olivine-type lithium metal phosphates (e.g., LiFePO₄, LiNiPO₄, LiCoPO₄, LiMnPO₄, Li₃Fe₂(PO₄)₃, and Li₃V₂(PO₄)₃), sodium iron oxide (e.g., NaFe₂O₃), sodium iron phosphate (e.g., NaFeP₂O₇), lithium nickel cobalt oxide (e.g., LiₓNi_{y}Co_{z}O₂), lithium nickel manganese oxide (e.g., LiₓNi_{y}Mn_{z}O₂, LiₓNi_{y}Mn_{z}O₄, LiCoMnO₄, Li₂NiMn₃O₈, etc.), lithium nickel manganese cobalt oxide (e.g., LiₐNi_{b}Mn_{c}Co_{d}Oₑ in layered structures or layered-layered structures; and/or LiNiₓMn_{y}Co_{z}O₂, a NMC oxide material where x+y+z=1, such as LiNi_{0.33}Mn_{0.33}Co_{0.33}O₂, LiNi_{0.9}Mn_{0.05}Co_{0.05}O₂, LiNi_{0.6}Mn_{0.2}Co_{0.2}O₂, LiNi_{0.5}Mn_{0.3}Co_{0.2}O₂, LiNi_{0.4}Mn_{0.4}Co_{0.2}O₂, LiNi_{0.7}Mn_{0.15}Co_{0.15}O₂, LiNi_{0.8}Mn_{0.1}Co_{0.1}O₂, etc.), and/or a mixed metal oxide with doped metal, among others. Other examples include lithium cobalt aluminum oxide (e.g., Li_{c}Co_{y}Al_{z}Oₙ), lithium nickel cobalt aluminum oxide (e.g., LiₓNi_{y}Co_{z}AlₐO_{b}, such as LiNi_{0.85}Co_{0.1}Al_{0.05}O₂), sodium iron manganese oxide (e.g., NaₓFe_{y}Mn_{z}O₂), among others. Exemplary metal oxide materials include, but are not limited to, titanium oxide (TiₓO_{y}, such as Ti₂O₅), chromium oxide (CrₓO_{y}, such as Cr₂O₇), tin oxide (SnₓO_{y}, such as SnO₂, SnO, SnSiO₃, etc.), copper oxide (CuₓO_{y}, such as CuO, Cu₂O, etc), aluminum oxide (AlₓO_{y}, such as Al₂O₃,), manganese oxide (MnₓO_{y}), iron oxide (FeₓO_{y}, such as Fe₂O₃, etc.), among others.

In another example, a mixed metal oxide with doped metal is obtained; for example. Liₐ(NiₓMn_{y}Co_{z})MeO_{b} (where Me=doped metal of Al, Mg, Fe, Ti, Cr, Zr, or C), Liₐ(NiₓMn_{y}Co_{z})MeO_{b}F_{c} (where Me=doped metal of Al, Mg, Fe, Ti, Cr, Zr, or C), among others. Other metal oxide materials containing one or more lithium (Li), nickel (Ni), manganese (Mn), cobalt (Co), aluminum (Al), titanium (Ti), sodium (Na), tantalum (Ta), zirconium (Zr), zinc (Zn), potassium (K), rubidium (Rb), tungsten (W), vanadium (V), cesium (Cs), copper (Cu), magnesium (Mg), iron (Fe), silver (Ag), germanium (Ge)-containing, tin (Sn)-containing compound, silicon (Si)-containing compound, bromine (Br), iodine (I), scandium (Sc), niobium (Nb), neodymium (Nd), lanthanum (La), cerium (Ce), silicon (Si), chromium (Cr), gallium (Ga), barium (Ba), actinium (Ac), calcium (Ca), boron (B), arsenic (As), hafnium (Hf), molybdenum (Mo), tungsten (W), rhenium (Re), ruthenium (Ru), rhodium (Rh), platinum (Pt), osmium (Os), iridium (Ir), gold (Au), and combinations thereof can also be obtained. Other examples of cathode active materials can be found in U.S. patent application Ser. Nos. 13/900,915, 16/114,114, 16/747,450, 17/319,974, 17/319,974, 17/901,796, 13/901,035, 16/104,841, 17/133,478, 17/970,342, 13/901,121, 15/846,094, 16/679,085, 17/899,048, all of which are incorporated herein by reference in its entirety.

Additional examples of lithium-containing battery material include, but are not limited to, ceramic solid-state electrolyte material, garnet-type solid-state oxide electrolyte materials, lithium lanthanum zirconium oxide material, Li₆ALa₃Ta₂O₁₂ (A=Sr, Ba), NASICON (NaM2(PO4)3 M=Ge, Ti, Zr), LLTO Perovskite-Type Structure Electrolytes synthesis and transport properties of two-dimensional LixM1/3Nb1-xTixO3 (M=La, Nd) perovskite (ABO3)-type oxides, Li superionic conductor (LISICON)-type structure oxide electrolytes, lithium phosphorous-oxynitride (LiPON)), solid-state sulfide electrolyte materials, such as Argyrodit Electrolyte, lithium phosphorus sulfide (Li₃PS₄, LPS) electrolyte, Li₇P₃S₁₁, Li7P2S8, Li11-xM2-xP1+xS12 (M=Ge, Sn, Si) (LGPS)-Type Structures: LGPS, Li₇La₃Zr₂O₁₂, Li₇La₃Zr₂O₁₂ doped with one or more metals, Li_{6.75}La₃Zr_{1.75}Ta_{0.25}O₁₂, Li_{6.5}La₃Zr₂Al_{0.25}O₁₂, Li_{6.5}La₃Zr₂Al_{0.24}O₁₂, Li_{6.5}La₃Zr₂Al_{0.22}O₁₂, Li_{6.76}La_{2.87}Zr_{2.0}Al_{0.24}O_{12.35}, Li_{6.74}La_{2.96}Zr_{2.0}Al_{0.25}O_{12.45}, Li_{6.27}La_{3.22}Zr_{2.0}Al_{0.3}O_{12.39}, Li_{6.4}La_{2.6}Zr_{2.0}Al_{0.24}O_{11.98}, Li_{6.43}La_{2.93}Zr_{2.0}Al_{0.24}O_{12.08}, Li_{6.32}La_{3.2}Zr_{2.0}Al_{0.46}O_{12.9}, Li_{6.57}La_{2.99}Zr_{2.0}A1_{0.22}O_{12.22}, Li_{6.4}La₃Zr₂Al_{0.2}O₁₂, Li_{6.54}La_{2.82}Zr_{2.0}Al_{0.24}O_{12.08}, Li_{6.49}La_{3.28}Zr_{2.0}Al_{0.31}O_{12.7}, Li_{6.28}La₃Zr₂Al_{0.24}O₁₂, Li_{6.25}La_{3.01}Zr_{2.0}Al_{0.22}O_{11.92}, Li_{6.49}La_{3.02}Zr_{2.0}Al_{0.23}O_{12.2}, Li_{6.5}La₃Zr_{1.5}Ta_{0.5}O₁₂, Li_{6.15}La₃Zr_{1.75}Ta_{0.25}Al_{0.2}O₁₂, Li_{6.25}La₃Zr₂A1_{0.25}O₁₂, Li_{6.15}La₃Zr_{1.75}Ta_{0.25}Ga_{0.2}O₁₂, Li_{6.25}La₃Zr₂Ta_{0.25}Ga_{0.2}O₁₂, Li_{6.4}La₃Zr₂Ga_{0.2}O₁₂, Li_{6.4}La₃Zr_{1.4}Ta_{0.6}O₁₂, Li₅La₃Nb₂O₁₂, Li₅La₃Ta₂O₁₂, Li₅La₃Ti₂O₁₂, Li₆La₃Sr₁Ta₂O₁₂, Li₆La₃Ba₁Ta₂O₁₂, Li₆La₃Ba₁Ti₂O₁₂, Li_{1.26}La_{2.24}Ti₄O₁₂, Li_{1.36}La_{2.24}Ti₄O₁₂, Li_{1.72}La_{2.24}Ti_{3.8}Ge_{0.2}O₁₂, Li_{1.72}La_{2.24}Ti_{3.8}Ge_{0.2}O₁₂, Li_{1.36}La_{2.24}Ti₄O₁₂, Li_{1.72}La_{2,24}Ti_{3.8}Ge_{0.2}O₁₂, Li_{1.72}La_{2,24}Ti_{3.8}Ge_{0.2}O₁₂, Li_{1.36}La_{2.24}Ti₄O₁₂, Li_{1.72}La_{2.24}Ti_{3.8}Ge_{0.2}O₁₂, Li_{1.72}La_{2.24}Ti_{3.8}Ge_{0.2}O₁₂, Li_{6.25}La₃Zr₂Ta_{0.25} Ga_{0.2}O₁₂, a ceramic material having a chemical composition of Liₐ La_{b} Zr_{c}Al_{d} D1ₑ . . . DNₙ Oᵥ, wherein 6.2≤a≤7.2, 2.8≤b≤3.5, 1.2≤c≤2.2, 2.0≤v≤12, and wherein at least one of D₁, . . . , D_{N} is a metal, N≥0, 0≤d≤0.8, 0≤e≤0.8, and 0≤n≤0.8, wherein D₁, D₂, . . . , D_{N} is selected from the group consisting of Al, Ta, Ti, Ge, Mg, Mn, Zr, Zn, Nb, Ce, Sn, Ga, Ba, Ac, Ca, Sc, V, Cr, Fe, Cu, B, As, Hf, Mo, W, Re, Ru, Rh, Pt, Ag, Os, Ir, Au, F, Cl, I, Br, a ceramic material having a chemical composition of Liₐ La_{b} Zr_{c} D1_{d} D2ₑ . . . DNₙ Oᵥ, wherein 6.2≤a≤7.2, 2.8≤b≤3.5, 1.2≤c≤2.2, 2.0≤v≤12, and wherein at least one of D₁, D₂, . . . , D_{N} is a metal, N≥0, 0≤d≤0.8, 0≤e≤0.8, and 0≤n≤0.8, wherein D₁, D₂, . . . , D_{N} is selected from the group consisting of Al, Ta, Ti, Ge, Mg, Mn, Zr, Zn, Nb, Ce, Sn, Ga, Ba, Ac, Ca, Sc, V, Cr, Fe, Cu, B, As, Hf, Mo, W, Re, Ru, Rh, Pt, Ag, Os, Ir, Au, F, Cl, I, Br, and combinations thereof. For example, the solid-state electrolyte material may be Liₐ La_{b} D1_{c} D2_{d} . . . DNₙ Oᵥ, where 4.5≤a≤7.2, 2.8≤b≤3.5, 1.5≤c≤2.5, 0≤d≤1.2, 0≤n≤1.2, and 2≤v≤12, and at least one of D₁, D₂, . . . , D_{N} is a metal, and N≥1. As another example, the solid-state electrolyte material may be Li₅La₃Nb₂O₁₂, Li₅La₃Ta₂O₁₂, Li₅La₃Ti₂O₁₂, Li₆La₃Sr₁Ta₂O₁₂, Li₆La₃Ba₁Ta₂O₁₂, Li₆La₃Ba₁Ti₂O₁₂, Li_{1.26}La_{2.24}Ti₄O₁₂. In another example, the chemical composition of the solid-state electrolyte material is Liₐ Al_{b} P_{c} D1_{d} . . . DNₙ Oᵥ, wherein 1≤a≤2, 0.2≤b≤1.5, 1.0≤c≤3.5, 0≤d≤2.0, 0≤n≤2.0, and 0.2≤v≤12, and wherein at least one of D₁, D₂, . . . , D_{N} is a metal, and N≥1; for example, and Li_{1.5}Al_{0.5}Ti_{1.5}P₃O₁₂, Li_{1.5}Al_{0.5}Ge_{1.5}P₃O₁₂. As still another example, the chemical composition of the solid-state electrolyte material may be Liₐ P_{b} S_{c} D1_{d} . . . DNₙ Xᵥ, where 5≤a≤16, 0.5≤b≤4.5, 3≤c≤16, 0≤d≤1.5, 0≤n≤1.5, 0≤v≤4, and at least one of D₁, D₂, . . . , D_{N} is a metal, N≥0, and X is a halogen; for example, Li₇P₃S₁₁, Li₃P₁S₄, Li₆P₁S₅Cl, Li₆P₁S₅Br₁, Li₆P₁S₅I, Li₆P₁S₅F₁, Li₇P₂S₈I₁, Li₇P₂S₈Br₁, Li₇P₂S₈Cl₁, Li₇P₂S₈F₁, Li₁₅P₄S₁₆Cl₃, Li_{14.8} Mg_{0.1}P₄S₁₆Cl₃, Li_{9.54}Si_{1.74}P_{1.44}S_{11.7}Cl_{0.3}, Li₁₀Ge₁P₂S₁₂, Li₁₀Si₁P₂S₁₂, Li₁₀Sn₁P₂S₁₂, Li₁₀Si_{0.3}Sn_{0.7}P₂S₁₂, Li₁₀Al_{0.3}Sn_{0.7}P₂S₁₂, Li₁₁Al₁P₂S₁₂. In another embodiment, the solid-state electrolyte material is Liₐ Ge_{b} P_{c} D1_{d} . . . DNₙ Oᵥ, where 10≤a≤13, 0.1≤b≤2.0, 0.1≤c≤1.5, 0.1≤d≤2.0, 0.1≤n≤2.0, 2≤v≤12, and at least one of D₁, D₂, . . . , D_{N} is a metal, N≥0, N≥0; for example, Li₁₂Ge_{0.5}Al_{1.0}Si_{0.55}P_{1.0}O₁₂, Li_{10.59}Ge_{1.58}V_{0.9}P_{0.53}O₁₂.

In yet another embodiment, the lithium-containing battery material includes but is not limited to reacted, unreacted, partially reacted lithium source materials for manufacturing battery materials, such as lithium carbonate (Li₂CO₃), lithium hydroxide (LiOH), lithium chloride (LiCl), lithium sulfate (Li₂SO₄), lithium nitrate (LiNO₃), lithium phosphate (Li₃PO₄), lithium fluoride (LiF), spodumene ore (LiAl(Si₂O₆)), lithium cobalt oxide (LiCoO₂), lithium iron phosphate (LiFePO₄), lithium manganese oxide (LiMn₂O₄), lithium nickel cobalt manganese oxide (Li(NiCoMn)O₂), Lithium Nickel Oxide (LiNiO₂), Lithium Titanate (Li₄Ti₅O₁₂), among others.

In still another embodiment, the lithium-containing battery material includes but is not limited to undesired agglomerate materials such as undesired clumps of lithium carbonate, aggregated lithium hydroxide, unwanted clusters of lithium manganese oxide. Another embodiment of lithium-containing battery material includes but is not limited to battery materials with undesired crystal structures such as cathode materials with poor crystal alignment, lithium nickel cobalt manganese oxide (Li(NiCoMn)O2) with distorted crystal lattice, lithium Titanate (Li4Ti5O12) with irregular crystal formation. As another example, the lithium-containing battery material may be in solid or semi-solid form, such as in powders or solid particles.

At step 140, optionally, the leachate solution is heated to a high temperature of 30° C. or higher for a reaction time (such as 5 to 10 minutes or longer) to help dissolve the lithium-containing battery material within the leachate solution. In one example, the temperature, about 50° C. or higher, such as about 60° C. or higher, e.g., between 60° C. and 95° C. or at more than 70° C., such as 75° C. or higher. In another example, the reaction time period can be around 1 second to 1 hour, such as between 15 min and 12 hour, between 30 min and 6 hour, between 30 min and 240 min, between 60 min and 180 min.

At step 150, optionally, unwanted undissolved substances are removed using a removal technique and the leachate solution is purified. In one embodiment, the removal of the unwanted undissolved substances is conducted by a removal technique, e.g., centrifugation, filtration, size-exclusion column, chromatography, and the combination thereof, etc.

Furthermore, at step 160, metal hydroxide (Me(OH)ₓ) is added to the leachate solution. Examples of metal hydroxide (Me(OH)ₓ) include, but are not limited to, barium hydroxide (Ba(OH)₂), calcium hydroxide (Ca(OH)₂), lead hydroxide (Pb(OH)₂), strontium hydroxide (Sr(OH)₂), or combinations thereof, etc. The concentration of the metal hydroxide (Me(OH)ₓ) within the leachate solution may be adjusted to a concentration of more than 0.1M, such as 0.1M or more, such as 0.15M or more, such as 0.2M, such as 0.25M or more, such as 0.3M or more, such as 0.35M or more, such as 0.4M or more, such as 0.45M or more, such as 0.5M or more, such as 0.55M or more, such as 0.6M or more, such as 0.65M or more, such as 0.7M or more, such as 0.75M or more, such as 0.8M or more, such as 0.85M or more, such as 0.9M or more, such as 0.95M or more, such as 0.99M or more.

At step 170, an aqueous acid solution is used in small aliquots to titrate the leachate solution and maintained the leachate solution to be at a pH 7.0 or less, such as at pH 6.8 or less, such as at pH 6.5 or less, such as at pH 6.2 or less, such as at pH 6.0 or less, such as at pH 5.8 or less, such as at pH 5.5 or less, such as at pH 5.2 or less, such as at pH 5.0 or less, such as at pH 4.8 or less, such as at pH 4.5 or less, such as at pH 4.3 or less, such as at pH 4.0 or less, such as at pH 3.8 or less, such as at pH 3.6 or less, such as at pH 3.5 or less, such as at pH 3.2 or less, such as at pH 3.0 or less, such as at pH 2.8 or less, such as at pH 2.5 or less, such as at pH 2.3 or less, such as at pH 2.0 or less. Examples of the aqueous acid solution include, but are not limited to, acetic acid (CH₃COOH), nitric acid (HNO₃), oxalic acid (C₂H₂O₄), citric acid (C₆H₈O₇), malic acid (C₄H₆O₅), ascorbic acid, lactic acid (C₃H₆O₃), formic acid (CH₂O₂), uric acid (C₅H₄N₄O₃), tartaric acid (C₄H₆O₆), phosphoric acid (H₃PO₄), hydrochloric acid (HCl), sulfuric acid (H₂SO₄), hydrofluoric acid (HF), carbonic acid (H₂CO₃), hydrobromic acid (HBr), hydroiodic acid (HI), perchloric acid (HClO), formic acid (HCOOH), butyric acid (CH₃CH₂CH₂COOH), oxalic acid (H₂C₂O₄), lactic acid (CH₃CH(OH)COOH), benzoic acid (C₆H₅COOH), maleic acid (HO₂CCH═CHCO₂H), succinic acid (HOOCCH₂CH₂COOH), sulfurous acid (H₂SO₃), boric acid (H₃BO₃), acetylsalicylic acid (aspirin, C₃H₈O₄), chromic acid (H₂CrO₄), hydrocyanic acid (HCN), hydrogen sulfide (H₂S), hydrosulfuric acid (H₂SO₂), and combinations thereof.

At step 180, a precipitate having metal sulfate (Me_{y}SO₄) is formed and obtained within the leachate solution. Maintaining the leachate solution at low pH helps metal sulfate (Me_{y}SO₄) salts to form and to be precipitated in the leachate solution. For example, depending on the species of Me(OH)ₓ added to the leachate solution at step 160, a precipitate, such as barium sulfate (BaSO₄), calcium sulfate (CaSO₄), lead sulfate (PbSO₄), strontium sulfate (SrSO₄), and combinations thereof, etc., can be formed and precipitated in the leachate solution.

At step 190, solid forms of metal sulfate (MeSO₄) are separated from the leachate solution and metal-containing organic and/or inorganic salt solution is obtained. The separation of the metal sulfate precipitates from the leachate solution is performed using techniques, such as centrifugation, filtration, size-exclusion column, chromatography, and the combination thereof. Once solid forms of metal sulfate (MeSO₄), such as barium sulfate (BaSO₄), calcium sulfate (CaSO₄), lead sulfate (PbSO₄), strontium sulfate (SrSO₄), etc., are removed from the leachate solution, the remaining solution is a battery material-related metal-containing organic and/or inorganic salt solution having metal ions and organic acid. Various processing technique can be performed to collect these metal salts, e.g., chemical precipitation, solvent extraction, electrochemical deposition, electrochemical plating, and combinations thereof.

Method 100 can be used to process various battery related metal material to obtain metal-containing organic and/or inorganic salt solution or compound, and is not just limited to obtaining one specific compound. Specifically, the metal salts obtained are selected from the group consisting of lithium salts, cobalt salts, nickel salts, aluminum salts, manganese salts, magnesium salts, lanthanum salts, zirconium salts, strontium salts, barium salts, sodium salts, germanium salts, titanium salts, neodymium salts, silicon salts, tin salts, tantalum salts, zinc salts, niobium salts, cerium salts, gallium salts, actinium salts, calcium salts, scandium salts, vanadium salts, chromium salts, iron salts, copper salts, boron salts, arsenic salts, hafnium salts, molybdenum salts, tungsten salts, rhenium salts, ruthenium salts, rhodium salts, platinum salts, silver salts, osmium salts, iridium salts, gold salts, fluorine salts, and combinations thereof.

In one embodiment, the metal-containing organic and/or inorganic salt solution obtained from the method 100 includes a lithium-containing salt, such as lithium acetate (C₂H₃OOLi), lithium nitrate (LiNO₃), lithium citrate (Li₃C₆H₅O₇), lithium oxalate (Li₂C₂O₄), lithium malate (Li₂C₄H₄O₅), lithium malate, lithium ascorbate, lithium lactate (CH₃CH(OH)COOLi), lithium formate (CHLiO₂), lithium urate (C₅H₃LiN₄O₃), lithium tartrate (C₄H₄Li₂O₆), and the combinations thereof. In another embodiment, the metal-containing organic and/or inorganic salt solution obtained from the method 100 includes a nickel (Ni)-containing salt, such as nickel acetate (C₂H₃OONi), nickel nitrate (NiNO₃), nickel citrate (Ni₃C₆H₅O₇), nickel oxalate (C₂Ni₂O₄), nickel malate (C₄H₄Ni₂O₅), nickel malate, nickel ascorbate, nickel lactate (CH₃CH(OH)COONi), nickel formate (CHNiO₂), nickel urate (C₅H₃NiN₄O₃), nickel tartrate (C₄H₄Ni₂O₆), and the combinations thereof.

In yet another embodiment, the metal-containing organic and/or inorganic salt solution obtained from the method 100 includes a cobalt (Co)-containing salt, such as cobalt acetate, cobalt nitrate, cobalt citrate, cobalt oxalate, cobalt malate, cobalt malate, cobalt ascorbate, cobalt lactate, cobalt formate, cobalt urate, cobalt tartrate, and the combinations thereof. In still another embodiment, the metal-containing organic and/or inorganic salt solution obtained from the method 100 includes an aluminum (Al)-containing salt, such as aluminum acetate, aluminum nitrate, aluminum citrate, aluminum oxalate, aluminum malate, aluminum malate, aluminum ascorbate, aluminum lactate, aluminum formate, aluminum urate, aluminum tartrate, and the combinations thereof.

In another embodiment, the metal-containing organic and/or inorganic salt solution obtained from the method 100 includes an manganese (Mn)-containing salt, such as manganese acetate, manganese nitrate, manganese citrate, manganese oxalate, manganese malate, manganese malate, manganese ascorbate, manganese lactate, manganese formate, manganese urate, manganese tartrate, and the combinations thereof. In yet another embodiment, the metal-containing organic and/or inorganic salt solution obtained from the method 100 includes a magnesium (Mg)-containing salt, such as magnesium acetate, magnesium nitrate, magnesium citrate, magnesium oxalate, magnesium malate, magnesium malate, magnesium ascorbate, magnesium lactate, magnesium formate, magnesium urate, magnesium tartrate, and the combinations thereof.

In still another embodiment, the metal-containing organic and/or inorganic salt solution obtained from the method 100 includes a lanthanum (La)-containing salt, such as lanthanum acetate, lanthanum nitrate, lanthanum citrate, lanthanum oxalate, lanthanum malate, lanthanum malate, lanthanum ascorbate, lanthanum lactate, lanthanum formate, lanthanum urate, lanthanum tartrate, and the combinations thereof. In yet another embodiment, the metal-containing organic and/or inorganic salt solution obtained from the method 100 includes a zirconium (Zr)-containing salt, such as zirconium acetate, zirconium nitrate, zirconium citrate, zirconium oxalate, zirconium malate, zirconium malate, zirconium ascorbate, zirconium lactate, zirconium formate, zirconium urate, zirconium tartrate, and the combinations thereof.

Further, the metal-containing organic and/or inorganic salt solution can be processed to separate various metal ions into metals, such as lithium and/or non-lithium metal so as to recover these high value metals independently. Since all of the valuable metals are kept in the soluble ionic form, it is easy to separate each of the metal one by one, so the collection method is easy to perform.

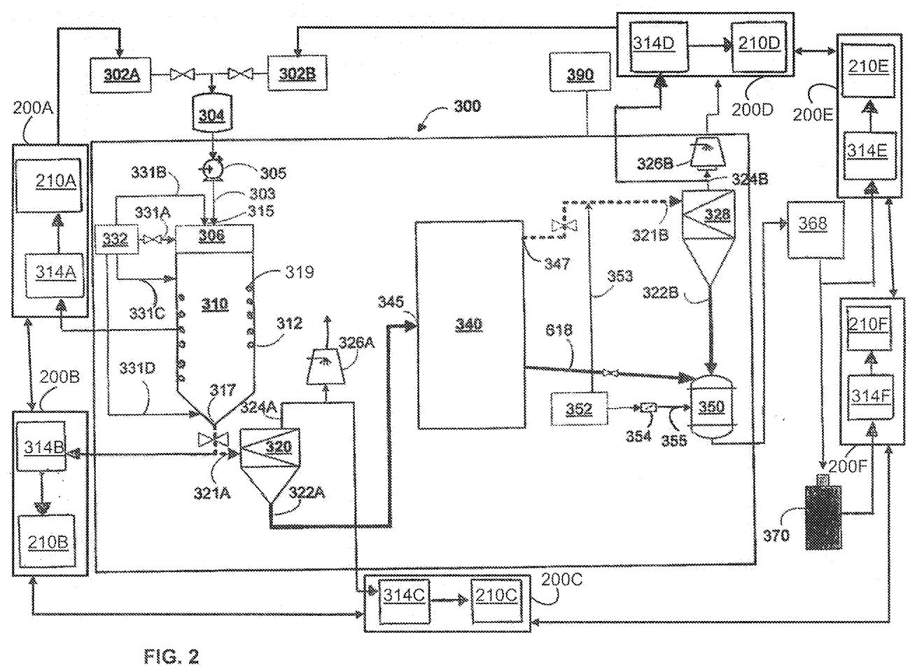

FIG. 2 is a schematic of the system 300, which is one example of an integrated tool/apparatus that can be used to carry out a fast, simple, continuous, low cost and high-yield manufacturing process for preparing a material for a battery electrochemical cell. System 300 can be used in a process, such as method 100, to recover and reclaim a metal-containing organic and/or inorganic salt solution, while system 300 is producing a lithium-containing battery material. Specifically, lithium-containing battery material can be recovered from system 300 by connecting the system 300 to the one or more recovering apparatuses 200, 200A, 200B, 200C, 200D, 200E, 200F.

System 300 is connected to a liquid mixer 304, which in turn is connected to two or more reactant sources 302A, 302B. The reactant sources 302A, 302B are provided to store various precursor compounds and liquid solvents. Desired amounts of precursor compounds (in solid or liquid form) and solvents are dosed and delivered from the reactant sources 302A, 302B to the liquid mixer 304 so that the precursor compounds can be dissolved and/or dispersed in the solvent and mix well into a liquid mixture. If necessary, the liquid mixer 304 is heated to a temperature, such as between 30° C. and 90° C. to help uniformly dissolve, disperse, and/or mix the precursors. The liquid mixer 304 is optionally connected to a pump 305, which pumps the liquid mixture from the liquid mixer 304 into the mist generator 306 of the system 300 to generate a mist.

The mist generator 306 converts the liquid mixture into a mist with desired droplet size and size distribution. In addition, the mist generator 306 is coupled to the first reaction chamber 310 in order to dry and remove moisture from the mist and obtain thoroughly-mixed solid precursor particles. In one embodiment, the mist generator 306 is positioned near the top of the first reaction chamber 310 that is positioned vertically (e.g., a dome-type drying chamber, etc.) to inject the mist into the first reaction chamber 310 and pass through the drying chamber vertically downward. Alternatively, the mist generator can be positioned near the bottom of the first reaction chamber 310 that is vertically positioned to inject the mist upward into the drying chamber to increase the residence time of the mist generated therein. In another embodiment, when the first reaction chamber 310 is positioned horizontally (e.g., a tube drying chamber, etc.) and the mist generator 306 is positioned near one end of the first reaction chamber 310 such that a flow of the mist, being delivered from the one end through another end of the first reaction chamber 310, can pass through a path within the first reaction chamber 310 for the length of its residence time.

The first reaction chamber 310 generally includes a chamber inlet 315, a chamber body 312, and a chamber outlet 317. In one configuration, the mist generator 306 is positioned inside the first reaction chamber 310 near the chamber inlet 315 and connected to a liquid line 303 adapted to flow the liquid mixture therein from the liquid mixer 304. For example, the liquid mixture within the liquid mixer 304 can be pumped by the pump 305 through the liquid line 303 connected to the chamber inlet 315 into the internal volume of the first reaction chamber 310. Pumping of the liquid mixture by the pump 305 can be configured, for example, continuously at a desired delivery rate (e.g., adjusted by a metered valve or other means) to achieve good process throughput of system 300. In another configuration, the mist generator 306 is positioned outside the first reaction chamber 310 and the mist generated therefrom is delivered to the first reaction chamber 310 via the chamber inlet 315.

One or more gas lines (e.g., gas lines 331A, 331B, 331C, 331D, etc.) can be coupled to various portions of the first reaction chamber 310 and adapted to flow a gas from a gas source 332 into the first reaction chamber 310. A flow of the gas stored in the gas source 332 can be delivered, concurrently with the formation of the mist inside first reaction chamber 310, into the first reaction chamber 310 to carry the mist through the first reaction chamber 310, remove moisture from the mist, and form a gas-solid mixture containing the precursors. Also, the flow of the gas can be delivered into the first reaction chamber 310 prior to the formation of the mist to fill and preheat an internal volume of the first reaction chamber 310 prior to generating the mist inside the first reaction chamber 310.

In one example, the gas line 331A is connected to the top portion of the first reaction chamber 310 to deliver the gas into the mist generator 306 positioned near the chamber inlet 315 to be mixed with the mist generated by the mist generator 306 inside the first reaction chamber 310. In one embodiment, the gas is preheated to a temperature of between 70° C. and 600° C. to mix with and remove moisture from the mist.

As another example, the gas line 331B delivering the gas therein is connected to the chamber inlet 315 of the first reaction chamber 310, in close proximity with the liquid line 303 having the liquid mixture therein. Accordingly, the gas can thoroughly mix with the mist of the liquid mixture inside the first reaction chamber 310.

In another example, the gas line 331C is connected to the chamber body 312 of the first reaction chamber 310 to deliver the gas therein and mix the gas with the mist generated from the mist generator 306. In addition, the gas line 331D connected to the first reaction chamber 310 near the chamber outlet 317 may be used to ensure the gas-solid mixture formed within the first reaction chamber 310 is uniformly mixed with the gas.

The flow of the gas may be pumped through an air filter to remove any particles, droplets, or contaminants, and the flow rate of the gas can be adjusted by a valve or other means. In one embodiment, the gas is heated to a drying temperature to mix with the mist and remove moisture from the mist. It is designed to obtain spherical solid particles from a thoroughly-mixed liquid mixture of two or more precursors after drying the mist of the liquid mixture. In contrast, conventional solid-state manufacturing processes involve mixing or milling a solid mixture of precursor compounds, resulting in uneven mixing of precursors.

Once the mist of the liquid mixture is dried and formed into a gas-solid mixture with the gas, the gas-solid mixture is delivered out of the first reaction chamber 310 via the chamber outlet 317. The first reaction chamber 310 is coupled to the gas-solid separator 320 of the system 300. The gas-solid separator 320 collects chamber products (e.g., a gas-solid mixture having the dried particles of the two or more precursors mixed together) from the chamber outlet 317.

The gas-solid separator 320 includes a separator inlet 321A, two or more separator outlets 322A, 324A. The separator inlet 321A is connected to the chamber outlet 317 and adapted to collect the gas-solid mixture and other chamber products from the first reaction chamber 310. The gas-solid separator 320 separates the gas-solid mixture from the first reaction chamber 310 into one or more (first type of) solid particles (of a lithium containing battery material) and waste products. The separator outlet 322A is adapted to deliver the one or more solid particles (of a lithium containing battery material) to the second reaction chamber 340 for further processing and reactions. The separator outlet 324A is adapted to deliver waste products out of the gas-solid separator 320.

The waste products may be delivered into a gas abatement device 326A to be treated and released out of the system 300. The waste product may include, for example, water (H₂O) vapor, organic solvent vapor, nitrogen-containing gas, oxygen-containing gas, O₂, O₃, nitrogen gas (N₂), NO, NO₂, NO₂, N₂O, N₄O, NO₃, N₂O₃, N₂O₄, N₂O₅, N(NO₂)₃, carbon-containing gas, carbon dioxide (CO₂), CO, hydrogen-containing gas, H, chlorine-containing gas, Cl₂, sulfur-containing gas, SO₂, small particles of the one or more solid particles of a lithium cobalt oxide material, and combinations thereof.

The one or more solid particles (of a lithium containing battery material) may include at least particles of the two or more precursors that are dried and uniformly mixed together. It is contemplated to separate the one or more solid particles (of a lithium containing battery material) away from any side products, gaseous products or waste products, prior to reacting the two or more precursors in the second reaction chamber 340. Accordingly, the system 300 is designed to mix the two or more precursors uniformly, dry the two or more precursors, separate the dried two or more precursors, and react the two or more precursors into final reaction in a continuous manner.

Suitable gas-solid separators include cyclones, electrostatic separators, electrostatic precipitators, gravity separators, inertia separators, membrane separators, fluidized beds, classifiers, electric sieves, impactors, particles collectors, leaching separators, elutriators, air classifiers, leaching classifiers, and combinations thereof, among others.

Once the one or more (first type of) solid particles (of a lithium containing battery material) are separated and obtained, it is delivered into the second reaction chamber 340 for further reaction. The second reaction chamber 340 includes a gas inlet (not shown on the drawing), a reactor inlet 345, and a reactor outlet 347. The reactor inlet 345 is connected to the separator outlet 322A and adapted to receive the (first type of) solid particles. Optionally, a vessel (not shown on the drawing) is adapted to store the solid particles prior to adjusting the amounts of the solid particles delivered into the second reaction chamber 340.

The gas inlet (not shown in FIG. 2) of the second reaction chamber 340 can be coupled to a heating mechanism (not shown in FIG. 2) to heat a gas from a gas source to an annealing temperature of between 400° C. and 1200° C. The heating mechanism can be, for example, an electric heater, a gas-fueled heater, a burner, among other heaters. Additional gas lines can be used to deliver heated air or gas into the second reaction chamber 340, if needed. The pre-heated gas can fill the second reaction chamber 340 and maintained the internal temperature of the second reaction chamber 340, much better and more energy efficient than conventional heating of the chamber body of a reactor.

The gas flown inside the second reaction chamber 340 is designed to be mixed with the one or more solid particles (of a lithium containing battery material) inside the second reaction chamber 340. Thermal energy from the pre-heated gas is used as the energy source for reacting the one or more solid particles (of a lithium containing battery material) within the second reaction chamber 340 for a residence time of between 1 second and ten hours, or longer, depending on the reaction temperature and the type of the precursors initially delivered into the system 300. The second gas-solid mixture can then go through one or more reactions, including, but not limited to, oxidation, reduction, decomposition, combination reaction, phase-transformation, re-crystallization, single displacement reaction, double displacement reaction, combustion, isomerization, and combinations thereof. One embodiment of the invention provides the control of the temperature of the reactor 340 by the temperature of the heated gas. The use of the heated gas as the energy source inside the reactor 340 provides the benefits of fast heat transfer, precise temperature control, uniform temperature distribution therein, and/or easy to scale up, among others.

Once the reactions inside the second reaction chamber 340 are complete, for example, upon the formation of desired crystal structure, particle morphology, and particle size, reaction products are delivered out of the second reaction chamber 340 via the reactor outlet 347 and/or a reactor outlet 618. The cooled reaction products include a second type of solid particles containing, for example, oxidized reaction product particles of the precursor compounds which are suitable as a material of a battery cell.

Optionally, system 300 includes a gas-solid separator, such as a gas-solid separator 328, which collects the reaction products from the reactor outlet 347 of the second reaction chamber 340. The gas-solid separator 328 can be a particle collector, such as cyclone, electrostatic separator, electrostatic precipitator, gravity separator, inertia separator, membrane separator, fluidized beds classifiers electric sieves impactor, leaching separator, elutriator, air classifier, leaching classifier, and combinations thereof.

The gas-solid separator 328 of the system 300 generally includes a separator inlet 321B, a separator outlet 322B and a separator outlet 324B and is used to separate the reaction products into the solid particles and gaseous side products. The gaseous side products may be delivered into a gas abatement device 326B to be treated and released out of the system 300. The gaseous side products separated by the gas-solid separator 328 may generally contain water (H₂O) vapor, organic solvent vapor, nitrogen-containing gas, oxygen-containing gas, O₂, O₃, nitrogen gas (N₂), NO, NO₂, NO₂, N₂O, N₄O, NO₃, N₂O₃, N₂O₄, N₂O₅, N(NO₂)₃, carbon-containing gas, carbon dioxide (CO₂), CO, hydrogen-containing gas, H₂, chlorine-containing gas, Cl₂, sulfur-containing gas, SO₂, small particles of the solid particles, and combinations thereof. In addition, the system 300 may further include one or more cooling fluid lines 353, 355 connected to the reactor outlet 347 or the separator outlet 322A of the gas solid separator 328 and adapted to cool the reaction products and/or the solid particles. The cooling fluid line 353 is adapted to deliver a cooling fluid (e.g., a gas or liquid) from a source 352 to the separator inlet 321B of the gas-solid separator 328. The cooling fluid line 355 is adapted to deliver a cooling fluid, which may filtered by a filter 354 to remove particles, into a heat exchanger 350.

The heat exchanger 350 is adapted to collect and cool the solid particles and/or reaction products from the gas-solid separator 328 and/or the second reaction chamber 340 by flowing a cooling fluid through them. The cooling fluid has a temperature lower than the temperature of the reaction products and the solid particles delivered from the gas-solid separator 328 and/or the second reaction chamber 340. The cooling fluid may have a temperature of between 4° C. and 30° C. The cooling fluid may be liquid water, liquid nitrogen, an air, an inert gas or any other gas which would not react to the reaction products.

Final solid products particles are collected and cooled by one or more separators, cooling fluid lines, and/or heat exchangers, and once cooled, the solid particles are delivered out of the system 300 and collected in a final product collector 368. The solid particles may include oxidized form of precursors, such as an oxide material, suitable to be packed into a battery cell 370. Additional pumps may also be installed to achieve the desired pressure gradient.

A process control system 390 can be coupled to the system 300 at various locations to automatically control the manufacturing process performed by the system 300 and adjust various process parameters (e.g., flow rate, mixture ratio, temperature, residence time, etc.) within the system 300. For example, the flow rate of the liquid mixture into the system 300 can be adjusted near the reactant sources 302A, 302B, the liquid mixer 304, or the pump 305. As another example, the droplet size and generation rate of the mist generated by the mist generator 306 can be adjusted. In addition, flow rate and temperature of various gases flown within the gas lines 331A, 331B, 331C, 331D, 353, 355, etc., can be controlled by the process control system 390. In addition, the process control system 390 is adapted to control the temperature and the residence time of various gas-solid mixture and solid particles at desired level at various locations.

Accordingly, a continuous process for producing a material of a battery cell using a system having a mist generator, a drying chamber, one or more gas-solid separators and a reactor is provided. A mist generated from a liquid mixture of one or more metal precursor compounds in desired ratio is mixed with air and dried inside the drying chamber, thereby forming gas-solid mixtures. One or more gas-solid separators are used in the system to separate the gas-solid mixtures from the drying chamber into solid particles packed with the one or more metal precursors and continuously deliver the solid particles into the reactor for further reaction to obtain final solid material particles with desired ratio of two or more intercalated metals.

In one embodiment, preparation and manufacturing of a metal oxide material is provided. Depending on the details and ratios of the metal precursor compounds that are delivered into the system 300, the resulting final solid material particles obtained from the system 300 may be a metal oxide material, a doped metal oxide material, an inorganic metal salts, among others. In addition, the metal oxide materials can exhibit a crystal structure of metals in the shape of layered, spinel, olivine, etc. In addition, the morphology of the final solid product particles (such as the reaction product prepared using the method 100 and the system 300 as described herein) exists as desired solid powders. The particle sizes of the solid powders range between 10 nm and 100 μm.

For mixed metal oxide materials, it is desired to control the composition of a final reaction product material by the ratio of the precursor compounds added in a liquid mixture added to the system 300.

Below is the recovering process within the system 300 using the recovering apparatuses. Each and every recovering apparatuses 200A, 200B, 200C, 200D, 200E, 200F has at least one collector (collectors 314A, 314B, 314C, 314D, 314E, 314F) and at least one leaching container (leaching containers 210A, 210B, 210C, 210D, 210E, 210F). The at least one collector (e.g. 314A, 314B, 314C, 314D, 314E, 314F) is to collect lithium-containing battery material (e.g. one or more residues 319) from the system 300.

Accordingly, the solid form of the lithium-containing battery material is dissolved in the leachate solution, which comprises sulfuric acid (H₂SO₄), and optionally, one or more reducing agents.

The at least one leaching container (e.g. 210A, 210B, 210C, 210D, 210E, 210F) is connected to the at least one collector (e.g. 314A, 314B, 314C, 314D, 314E, 314F). The at least one leaching container (e.g. 210A, 210B, 210C, 210D, 210E, 210F) contains a leaching solution comprising water and sulfuric acid (H₂SO₄).

In one embodiment, recovering apparatus 200A includes a collector 314A and a leaching container 210A where the recovering apparatus 200A is connected to chamber body 312. Reactant sources (e.g. 302A and 302B) enter the system 300 from the liquid mixer 340. Then a liquid mixture comprising a lithium-containing solution is obtained. Exemplary lithium-containing solution include, but not limited to, lithium acetate (LiCH₃COO), lithium nitrate (LiNO₃), lithium citrate (Li₃C₆H₅O₇), lithium oxalate (Li₂C₂O₄), lithium malate (Li₂C₄H₄O₅), lithium ascorbate, lithium lactate (CH₃CH(OH)COOLi), lithium formate (LiCHO₂), lithium urate (LiC₅H₃N₄O₃), lithium tartrate (Li₂CH₄O₆), lithium sulfate (Li₂SO₄), lithium carbonate (Li₂CO₃), lithium hydroxide (LiOH), lithium chloride (LiCl).

The liquid mixture then passes through the mist generator 306, which converts the liquid mixture into a mist with desired droplet size and size distribution. The mist generator 306 is coupled to the first reaction chamber 310 in order to dry and remove moisture from the mist and obtain thoroughly-mixed solid precursor particles. Once the mist of the liquid mixture is dried and formed into a gas-solid mixture, it is delivered out of the first reaction chamber 310 via the chamber outlet 317. As the gas-solid mixture being dried in the first reaction chamber 310, one or more residues 319 are formed on the inner wall of the chamber body 312. By removing one or more residues 319 from the inner wall, the one or more residues 319 can be delivered to a collector 314A, and then sent to the recovering apparatus 200A, where method 100 is performed. Depending on the nature of the residues and the type of chamber involved, exemplary approaches of removing one or more residues 319 can be mechanical scrubbing or brushing, solvent cleaning, chemical cleaning, steam cleaning with high-temperature steam, ultrasonic waves, abrasive blasting, high-pressure water jetting, low-pressure or atmospheric-pressure plasma and combinations thereof.

In another embodiment, recovering apparatus 200B is connected to the chamber body 312 through the chamber outlet 317, and comprises of a collector 314B and a leaching container 210B. In this embodiment, once the mist of the liquid mixture is dried and formed into a gas-solid mixture, it is delivered out of the first reaction chamber 310 via the chamber outlet 317. The first reaction chamber 310 is coupled to the first gas-solid separator 320 of the system 300. The first gas-solid separator 320 collects chamber products (e.g., a gas-solid mixture having the gas and dried particles of the two or more precursors mixed together) from the chamber outlet 317. After the chamber products are delivered out of the first reaction chamber 310, some of them go through the gas-solid separator 320 for further processing, but the rest can be further recovered and sent to a collector 314B. Then, it is sent to the recovering apparatus 200B to be further processed under method 100.

In yet another embodiment, recovering apparatus 200C is connected to the gas-solid separator 320 through the separator outlet 324A, and comprises of a collector 314C and a leaching container 210C. In this embodiment, after the chamber product is delivered to the gas-solid separator 320, it is separated into a first type of solid particles and waste product. After the gas-solid separator 320 processes the chamber product and separate it into first type of solid particles and waste products, part of the waste products is delivered out of the processing system through the gas abatement device 326A, but part of the waste products are recollected to a collector 314C, and then to the recovering apparatus 200C to be further processed under method 100.

In still another embodiment, recovering apparatus 200D is connected to the gas-solid separator 328 through the fourth separator outlet 324B and comprise of a collector 314D and a leaching container 210D. After the separation in gas-solid separator 320, the first type of solid particles are delivered through the separator outlet 322A. Separator outlet 322A is adapted to deliver the first type of solid particles to the second reaction chamber 340 for further processing and reactions. The second separator outlet 324A is adapted to deliver waste products out of the first gas-solid separator 320. The waste products are delivered to a gas abatement device 326A for further processing.

Once the first type of solid particles is separated and obtained, it is delivered into the second reaction chamber 340 for further reaction. The first type of solid particles are mixed in the second reaction chamber 340 to form a second gas-solid mixture. Once the reaction is completed, the reaction products are delivered out of the second reaction chamber 340 via the reactor outlet 347 and/or a reactor outlet 348 and cooled down. The reaction products that pass through the reactor outlet 347 are delivered to the second gas-solid separator 328, which collects the reaction products from the reactor outlet of the second reaction chamber 340. The reaction products are further separated in the second gas-solid separator 328. The reaction products are separated into a second type of solid particles and gaseous side products. The gaseous side products may be delivered into a gas abatement device 326B to be treated and released out of the system 300. After the reaction products are sent to the gas-solid separator 328, the gaseous side products are being separated from the second type of solid particles. Some of the gaseous side products then go through the gas abatement device 326B for release, some of the gaseous side products are recollected to collector 314D, and then delivered to the recovering apparatus 200D as the materials for the method 100.

In one embodiment, recovering apparatus 200E is connected to the product collector 368 and comprise of a collector 314E and a leaching container 210E. For the reaction products that pass through the reactor outlet 348, they are delivered to a heat exchanger 350. The heat exchanger 350 is adapted to collect and cool the reaction products. After furthering processing, final reaction products are collected from the heat exchanger 350 to a final product collector 368. The final product can then be packed into a battery cell 370. In this embodiment, the materials used in method 100 are collected in the product collector 368. Specifically, after the final reaction products are delivered to the product collector 368, a binning process is performed. After the binning process, the final reaction products are categorized. Those with better quality will be sent to be packed into the battery cell 370. Those with lesser quality will be recollected to the collector 314E, then further delivered to the recovering apparatus 200E to perform method 100.

In one embodiment, recovering apparatus 200F is connected to at least one battery cell 370, and comprises of a collector 314F and a leaching container 210F. After the battery cell 370 is retired, it can also be recycled back to a collector 314F, and after some preliminary processing, to the recovering apparatus 200F to recover the metal in the battery through the method 100.

In one embodiment, the lithium-containing battery material collected from at least one collector (e.g. 314A, 314B, 314C, 314D, 314E, 314F) includes but is not limited to reacted, unreacted, partially reacted lithium source materials for manufacturing battery materials such as lithium carbonate (Li₂CO₃), lithium hydroxide (LiOH), lithium chloride (LiCl), lithium sulfate (Li₂SO₄), lithium nitrate (LiNO₃), lithium phosphate (Li₃PO₄), lithium fluoride (LiF), spodumene ore (LiAl(Si₂O₆)), lithium cobalt oxide (LiCoO₂), lithium iron phosphate (LiFePO₄), lithium manganese oxide (LiMn₂O₄) lithium nickel cobalt manganese oxide (Li(NiCoMn)O₂) lithium nickel oxide (LiNiO₂) lithium titanate (Li₄Ti₅O₁₂).

In another embodiment, the lithium-containing battery material collected from at least one collector (e.g. 314A, 314B, 314C, 314D, 314E, 314F) includes but not limited to undesired agglomerate materials such as undesired clumps of lithium carbonate, aggregated lithium hydroxide, unwanted clusters of lithium manganese oxide. Another embodiment of lithium-containing battery material includes but not limited to battery materials with undesired crystal structures such as cathode materials with poor crystal alignment, lithium nickel cobalt manganese oxide (Li(NiCoMn)O₂) with distorted crystal lattice, lithium Titanate (Li₄Ti₅O₁₂) with irregular crystal formation.

Additional examples of the lithium-containing battery material collected from at least one collector (e.g. 314A, 314B, 314C, 314D, 314E, 314F) includes but is not limited to ceramic solid-state electrolyte material, garnet-type solid-state oxide electrolyte materials, lithium lanthanum zirconium oxide material, Li₆ALa₃Ta₂O₁₂ (A=Sr, Ba), NASICON (NaM2(PO4)3 M=Ge, Ti, Zr), LLTO Perovskite-Type Structure Electrolytes synthesis and transport properties of two-dimensional LixM1/3Nb1-xTixO3 (M=La, Nd) perovskite (ABO3)-type oxides, Li superionic conductor (LISICON)-type structure oxide electrolytes, lithium phosphorous-oxynitride (LiPON)), solid-state sulfide electrolyte materials, such as Argyrodit Electrolyte, lithium phosphorus sulfide (Li₃PS₄, LPS) electrolyte, Li₇P₃S₁₁, Li7P2S8, Li11-xM2-xP1+xS12 (M=Ge, Sn, Si) (LGPS)-Type Structures: LGPS, Li₇La₃Zr₂O₁₂, Li₇La₃Zr₂O₁₂ doped with one or more metals, Li_{6.75}La₃Zr_{1.75}Ta_{0.25}O₁₂, Li_{6.5}La₃Zr₂Al_{0.25}O₁₂, Li_{6.5}La₃Zr₂Al_{0.24}O₁₂, Li_{6.5}La₃Zr₂Al_{0.22}O₁₂, Li_{6.76}La_{2.87}Zr_{2.0}Al_{0.24}O_{12.35}, Li_{6.74}La_{2.96}Zr_{2.0}Al_{0.25}O_{12.45}, Li_{6.27}La_{3.22}Zr_{2.0}Al_{0.3}O_{12.39}, Li_{6.4}La_{2.86}Zr_{2.0}Al_{0.24}O_{11.98}, Li_{6.43}La_{2.93}Zr_{2.0}Al_{0.24}O_{12.08}, Li_{6.32}La_{3.2}Zr_{2.0}Al_{0.46}O_{12.9}, Li_{6.57}La_{2.99}Zr_{2.0}Al_{0.22}O_{12.22}, Li_{6.4}La₃Zr₂Al_{0.2}O₁₂, Li_{6.54}La_{2.82}Zr_{2.0}Al_{0.24}O_{12.08}, Li_{6.49}La_{3.28}Zr_{2.0}Al_{0.31}O_{12.7}, Li_{6.28}La₃Zr₂Al_{0.24}O₁₂, Li_{6.25}La_{3.01}Zr_{2.0}Al_{0.22}O_{11.92}, Li_{6.49}La_{3.02}Zr_{2.0}Al_{0.23}O_{12.2}, Li_{6.5}La₃Zr_{1.5}Ta_{0.5}O₁₂, Li_{6.15}La₃Zr_{1.75}Ta_{0.25}Al_{0.2}O₁₂, Li_{6.25}La₃Zr₂Al_{0.25}O₁₂, Li_{6.15}La₃Zr_{1.75}Ta_{0.25}Ga_{0.2}O₁₂, Li_{6.25}La₃Zr₂Ta_{0.25}Ga_{0.2}O₁₂, Li_{6.4}La₃Zr₂Ga_{0.2}O₁₂, Li_{6.4}La₃Zr_{1.4}Ta_{0.6}O₁₂, Li₅La₃Nb₂O₁₂, Li₅La₃Ta₂O₁₂, Li₅La₃Ti₂O₁₂, Li₆La₃Sr₁Ta₂O₁₂, Li₆La₃Ba₁Ta₂O₁₂, Li₆La₃Ba₁Ti₂O₁₂, Li_{1.26}La_{2.24}Ti₄O₁₂, Li_{1.36}La_{2.24}Ti₄O₁₂, Li_{1.72}La_{2.24}Ti_{3.8}Ge_{0.2}O₁₂, Li_{1.72}La_{2.24}Ti_{3.8}Ge_{0.2}O₁₂, Li_{1.36}La_{2.24}Ti₄O₁₂, Li_{1.72}La_{2,24}Ti_{3.8}Ge_{0.2}O₁₂, Li_{1.72}La_{2,24}Ti_{3.8}Ge_{0.2}O₁₂, Li_{1.36}La_{2.24}Ti₄O₁₂, Li_{1.72}La_{2.24}Ti_{3.8}Ge_{0.2}O₁₂, Li_{1.72}La_{2.24}Ti_{3.8}Ge_{0.2}O₁₂, Li_{6.25}La₃Zr₂Ta_{0.25} Ga_{0.2}O₁₂, a ceramic material having a chemical composition of Liₐ La_{b} Zr_{c} Al_{d} D1ₑ . . . DNₙ Oᵥ, wherein a 6.2≤a≤7.2, 2.8≤b≤3.5, 1.2≤c≤2.2, 2.0≤v≤12, and wherein at least one of D₁, . . . , D_{N} is a metal, N≥0, 0≤d≤0.8, 0≤e≤0.8, and 0≤n≤0.8, wherein D₁, D₂, . . . , D_{N} is selected from the group consisting of Al, Ta, Ti, Ge, Mg, Mn, Zr, Zn, Nb, Ce, Sn, Ga, Ba, Ac, Ca, Sc, V, Cr, Fe, Cu, B, As, Hf, Mo, W, Re, Ru, Rh, Pt, Ag, Os, Ir, Au, F, CI, I, Br, a ceramic material having a chemical composition of Liₐ La_{b} Zr_{c} D1_{d} D2ₑ . . . DNₙ Oᵥ, wherein 6.2≤a≤7.2, 2.8≤b≤3.5, 1.2≤c≤2.2, 2.0≤v≤12, and wherein at least one of D₁, D₂, . . . , D_{N} is a metal, N≥0, 0≤d≤0.8, 0≤e≤0.8, and 0≤n≤0.8, wherein D₁, D₂, . . . , D_{N} is selected from the group consisting of Al, Ta, Ti, Ge, Mg, Mn, Zr, Zn, Nb, Ce, Sn, Ga, Ba, Ac, Ca, Sc, V, Cr, Fe, Cu, B, As, Hf, Mo, W, Re, Ru, Rh, Pt, Ag, Os, Ir, Au, F, CI, I, Br, and combinations thereof. For example, the solid-state electrolyte material may be Liₐ La_{b} D1_{c} D2_{d} . . . DNₙ Oᵥ, where 4.5≤a≤7.2, 2.8≤b≤3.5, 1.5≤c≤2.5, 0≤d≤1.2, 0≤n≤1.2, and 2≤v≤12, and at least one of D₁, D₂, . . . , D_{N} is a metal, and N≥1. As another example, the solid-state electrolyte material may be Li₅La₃Nb₂O₁₂, Li₅La₃Ta₂O₁₂, Li₅La₃Ti₂O₁₂, Li₆La₃Sr₁Ta₂O₁₂, Li₆La₃Ba₁Ta₂O₁₂, Li₆La₃Ba₁Ti₂O₁₂, Li_{1.26}La_{2.24}Ti₄O₁₂. In another example, the chemical composition of the solid-state electrolyte material is Liₐ Al_{b} P_{c} D1_{d} . . . DNₙ Oᵥ, wherein 1≤a≤2, 0.2≤b≤1.5, 1.0≤c≤3.5, 0≤d≤2.0, 0≤n≤2.0, and 0.2≤v≤12, and wherein at least one of D₁, D₂, . . . , D_{N} is a metal, and N≥1; for example, and Li_{1.5}Al_{0.5}Ti_{1.5}P₃O₁₂, Li_{1.5}Al_{0.5}Ge_{1.5}P₃O₁₂. As still another example, the chemical composition of the solid-state electrolyte material may be Liₐ P_{b} S_{c} D1_{d} . . . DNₙ Xᵥ, where 5≤a≤16, 0.5≤b≤4.5, 3≤c≤16, 0≤d≤1.5, 0≤n≤1.5, 0≤v≤4, and at least one of D₁, D₂, . . . , D_{N} is a metal, N≥0, and X is a halogen; for example, Li₇P₃S₁₁, Li₃P₁S₄, Li₆P₁S₅Cl, Li₆P₁S₅Br₁, Li₆P₁S₅I, Li₆P₁S₅F₁, Li₇P₂S₈I₁, Li₇P₂S₈Br₁, Li₇P₂S₈Cl₁, Li₇P₂S₈F₁, Li₁₅P₄S₁₆Cl₃, Li_{14.8}Mg_{0.1}P₄S₁₆Cl₃, Li_{9.54}Si_{1.74}P_{1.44}S_{11.7}Cl_{0.3}, Li₁₀Ge₁P₂S₁₂, Li₁₀Si₁P₂S₁₂, Li₁₀Sn₁P₂S₁₂, Li₁₀Si_{0.3}Sn_{0.7}P₂S₁₂, Li₁₀Al_{0.3}Sn_{0.7}P₂S₁₂, Li₁₁Al₁P₂S₁₂. In another embodiment, the solid-state electrolyte material is Liₐ Ge_{b} P_{c} D1_{d} . . . DNₙ Oᵥ, where 10≤a≤13, 0.1≤b≤2.0, 0.1≤c≤1.5, 0.1≤d≤2.0, 0.1≤n≤2.0, 2≤v≤12, and at least one of D₁, D₂, . . . , D_{N} is a metal, N≥0, N≥0; for example, Li₁₂Ge_{0.5}Al_{1.0}Si_{0.55}P_{1.0}O₁₂, Li_{10.59}Ge_{1.58}V_{0.9}P_{0.53}O₁₂.

As another example, the lithium-containing battery material collected from at least one collector (e.g. 314A, 314B, 314C, 314D, 314E, 314F) may be in solid or semi-solid form, such as in powders or solid particles.

The number of the recovering apparatus, the configuration of each one of the apparatuses, and whereto they are connected, are not limited to the above description. The several different configurations in the system 300 suggested above can all be used to collect the lithium-containing battery material 220.

The utilization of the instant invention for reclamation, recycling, and reuse of waste, by-product, and side-product materials in battery material manufacturing offers substantial benefits that encompass economic, efficiency, and environmental aspects. This approach contributes to cost reduction, increased yield rates, and noteworthy environmental advantages, making it a pivotal strategy in sustainable battery material production.

The instant invention provides an efficient means of extracting valuable metals from waste, by-product, and side-product materials, facilitating their reintegration into the battery material manufacturing process. This invention reduces the need for acquiring raw materials, which can be expensive and subject to price fluctuations. By recovering metals from secondary sources, manufacturers can significantly cut down on procurement costs, ultimately leading to a more economical production process. Furthermore, the reclamation of valuable metals through the instant invnetion directly translates into higher yield rates. By harnessing metals that might have otherwise been discarded, manufacturers optimize their resource utilization, minimizing wastage and maximizing the conversion of input materials into usable battery components. This not only enhances overall production efficiency but also contributes to a more sustainable and responsible use of natural resources.

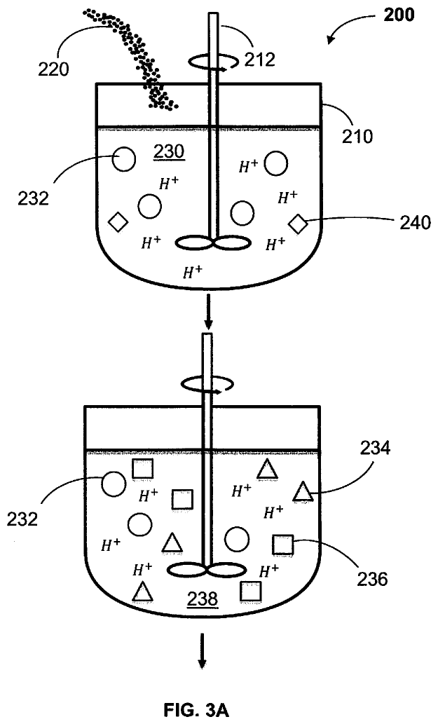

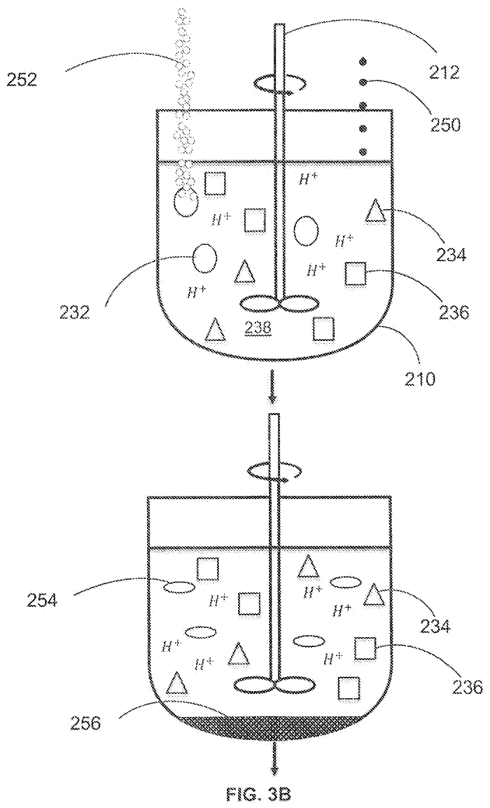

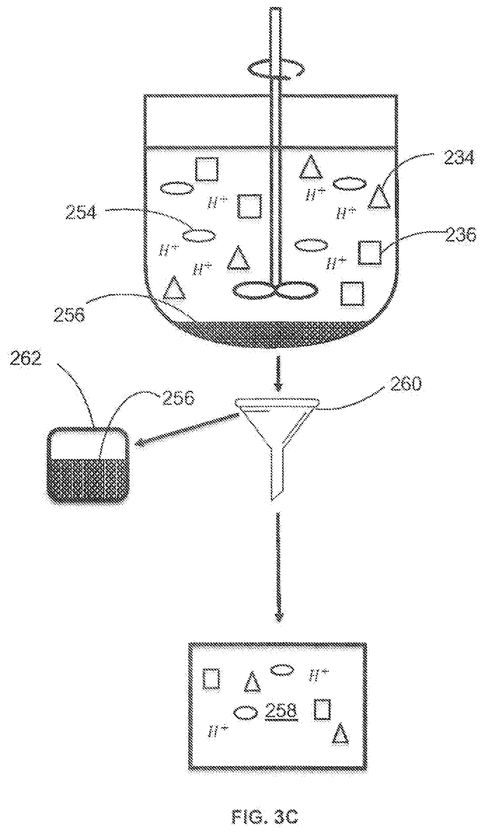

As addressed in FIG. 1 and below, method 100 includes steps 110, 120, 130, 140, 150, 160, 170, 180, and 190. Not all of the steps above are necessary to achieve the goal of this invention. Some of the steps, such as step 140 and step 150, can be optional. FIG. 3A, FIG. 3B, and FIG. 3C are the schematics of the exemplary process illustrated in FIG. 1.

As shown in FIG. 1 and FIG. 3A, the first step in the process is step 110. Specifically, the step 110 includes the preparation of a leaching solution 230 comprising sulfuric acid and water. The leaching solution 230 comprises sulfuric acid (H₂SO₄) and water. Furthermore, in the figures, the sulfuric acid is present in the form of Sulfate (SO₄²⁻) 232 and Free Hydrogen Ion H⁺.

Besides, a reducing agent 240 can also be added to the leaching solution 230 to speed up the processing time. The preferred reducing agent 240 is selected from the group consisting of hydrogen peroxide (H₂O₂), sodium hydrogen sulfite (sodium bisulfite, NaHSO₃), glucose (C₆H₁₂O₆), sucrose (C₁₂H₂₂O₁₁), and combinations thereof. In the flow chart from FIG. 1, hydrogen peroxide is used as an example of the possible reducing agent 240, but it is not limited thereto. Furthermore, the leaching solution 230 further comprises metal hydroxide (Me(OH)ₓ).

FIG. 1 and FIG. 3A further illustrate step 120. Step 120 starts by adding the lithium-containing battery material 220 into the leaching solution 230. Specifically, in one embodiment, the lithium-containing battery material 220 is selected from the group consisting of lithium cobalt oxide (LiCoO₂), lithium nickel oxide (LiNiO₂), lithium manganese oxide, lithium nickel manganese cobalt oxide (general formula: LiNiₓMn_{y}Co_{z}O₂), lithium nickel cobalt aluminum oxide (NCA), lithium nickel cobalt manganese aluminum oxide, lithium nickel magnesium cobalt oxide, Lithium lanthanum zirconium oxide (LLZO, solid state lithium-stuffed garnet material), and combinations thereof.

In one embodiment, the lithium-containing battery material collected from at least one collector (e.g. 314A, 314B, 314C, 314D, 314E, 314F) includes but is not limited to reacted, unreacted, partially reacted lithium source materials for manufacturing battery materials such as lithium carbonate (Li₂CO₃), lithium hydroxide (LiOH), lithium chloride (LiCl), lithium sulfate (Li₂SO₄), lithium nitrate (LiNO₃), lithium phosphate (Li₃PO₄), lithium fluoride (LiF), spodumene ore (LiAl(Si₂O₆)), lithium cobalt oxide (LiCoO₂), lithium iron phosphate (LiFePO₄), lithium manganese oxide (LiMn₂O₄) lithium nickel cobalt manganese oxide (Li(NiCoMn)O₂) lithium nickel oxide (LiNiO₂) lithium titanate (Li₄Ti₅O₁₂).

In another embodiment, the lithium-containing battery material collected from at least one collector (e.g. 314A, 314B, 314C, 314D, 314E, 314F) includes but is not limited to undesired agglomerate materials such as undesired clumps of lithium carbonate, aggregated lithium hydroxide, unwanted clusters of lithium manganese oxide. Another embodiment of lithium-containing battery material includes but not limited to battery materials with undesired crystal structures such as cathode materials with poor crystal alignment, lithium nickel cobalt manganese oxide (Li(NiCoMn)O₂) with distorted crystal lattice, lithium Titanate (Li₄Ti₅O₁₂) with irregular crystal formation.

In still another embodiment, the lithium-containing battery material collected from at least one collector (e.g. 314A, 314B, 314C, 314D, 314E, 314F) includes but is not limited to anode materials. Exemplary anode materials include but are not limited to alkali metals (such as lithium, sodium, potassium, etc.), other metals or transition metals (such as tantalum, titanium zinc, iron, the elements on the Group 2 of the periodic table (e.g., magnesium, calcium, , etc.), the elements on Group 13 and 14 of the periodic table such as aluminum (Al), germanium (Ge), etc.), a carbonaceous material, and/or metal alloys of two or more of the aforementioned metals. Exemplary anode materials include but not limited to lithium metal, lithium alloys (e.g. lithium-aluminum alloys, lithium-tin alloys, lithium-lead alloys, and lithium-silicon alloys), lithium-containing metal oxides (e.g. lithium titanium oxide), lithium-containing metal sulfides, lithium-containing metal nitrides (e.g. lithium cobalt nitride, lithium iron nitride, lithium manganese nitride), and carbonaceous materials such as graphite, carbon-based materials such as lithium titanate (Li₄Ti₅O₁₂), SiO-based composites, SiO—Sn—Co/graphite (G) composites, Si, Sn—Co—C mixed composites, and lithium coated with a solid electrolyte.

In yet another embodiment, the lithium-containing battery material collected from at least one collector (e.g. 314A, 314B, 314C, 314D, 314E, 314F) includes but is not limited to cathode active materials. Exemplary cathode active materials include but are not limited to mixed metal oxides, a metal oxide with two or more metals (MeₓMe′_{y}O_{z}), a metal oxide with three or four intercalated metals, lithium transitional metal oxide (LiMeO₂), lithium titanium oxide (e.g., Li₄Ti₅O₁₂), lithium cobalt oxide (e.g., LiCoO₂), lithium manganese oxide (e.g., LiMn₂O₄), lithium nickel oxide (e.g., LiNiO₂), lithium iron phosphate (e.g., LiFePO₄), lithium cobalt phosphate (e.g., LiCoPO₄), lithium manganese phosphate (e.g., LiMnPO₄), lithium nickel phosphate (e.g., LiNiPO₄), sodium iron oxide (e.g., NaFe₂O₃), sodium iron phosphate (e.g., NaFeP₂O₇), lithium nickel manganese cobalt oxide (LiNiₓMn_{y}Co_{z}O₂), lithium nickel cobalt aluminum oxide (NCA), lithium nickel cobalt manganese aluminum oxide, lithium nickel manganese cobalt oxide, lithium nickel magnesium cobalt oxide, lithium lanthanum zirconium oxide (LLZO, solid state lithium-stuffed garnet material), olivine-type lithium metal phosphates (e.g., LiFePO₄, LiNiPO₄, LiCoPO₄, LiMnPO₄, Li₃Fe₂(PO₄)₃, and Li₃V₂(PO₄)₃), sodium iron oxide (e.g., NaFe₂O₃), sodium iron phosphate (e.g., NaFeP₂O₇), among others, lithium nickel cobalt oxide (e.g., LiₓNi_{y}Co_{z}O₂), lithium nickel manganese oxide (e.g., LiₓNi_{y}Mn_{z}O₂, LiₓNi_{y}Mn_{z}O₄, LiCoMnO₄, Li₂NiMn₃O₈, etc.), lithium nickel manganese cobalt oxide (e.g., LiₐNi_{b}Mn_{c}Co_{d}Oₑ in layered structures or layered-layered structures; and/or LiNiₓMn_{y}Co_{z}O₂, a NMC oxide material where x+y+z=1, such as LiNi_{0.33}Mn_{0.33}Co_{0.33}O₂, LiNi_{0.9}Mn_{0.05}Co_{0.05}O₂, LiNi_{0.6}Mn_{0.2}Co_{0.2}O₂, LiNi_{0.5}Mn_{0.3}Co_{0.2}O₂, LiNi_{0.4}Mn_{0.4}Co_{0.2}O₂, LiNi_{0.7}Mn_{0.15}Co_{0.15}O₂, LiNi_{0.8}Mn_{0.1}Co_{0.1}O₂, etc.; and/or a mixed metal oxide with doped metal, among others. Other examples include lithium cobalt aluminum oxide (e.g., LiₓCo_{y}Al_{z}Oₙ), lithium nickel cobalt aluminum oxide (e.g., LiₓNi_{y}Co_{z}AlₐO_{b}, such as LiNi_{0.85}Co_{0.1}Al_{0.05}O₂), sodium iron manganese oxide (e.g., NaₓFe_{y}Mn_{z}O₂), among others. Exemplary metal oxide materials include, but are not limited to, titanium oxide (TiₓO_{y}, such as Ti₂O₅), chromium oxide (CrₓO_{y}, such as Cr₂O₇), tin oxide (SnₓO_{y}, such as SnO₂, SnO, SnSiO₃, etc.), copper oxide (CuₓO_{y}, such as CuO, Cu₂O, etc), aluminum oxide (AlₓO_{y}, such as Al₂O₃,), manganese oxide (MnₓO_{y}), iron oxide (FeₓO_{y}, such as Fe₂O₃, etc), among others. In another example, a mixed metal oxide with doped metal is obtained; for example. Liₐ(NiₓMn_{y}Co_{z})MeO_{b} (where Me=doped metal of Al, Mg, Fe, Ti, Cr, Zr, or C), Liₐ(NiₓMn_{y}Co_{z})MeO_{b}F_{c} (where Me=doped metal of Al, Mg, Fe, Ti, Cr, Zr, or C), among others. Other metal oxide materials containing one or more lithium (Li), nickel (Ni), manganese (Mn), cobalt (Co), aluminum (Al), titanium (Ti), sodium (Na), tantalum (Ta), zirconium (Zr), zinc (Zn), potassium (K), rubidium (Rb), tungsten (W), vanadium (V), cesium (Cs), copper (Cu), magnesium (Mg), iron (Fe), silver (Ag), germanium (Ge)-containing, tin (Sn)-containing compound, silicon (Si)-containing compound, bromine (Br), iodine (I), scandium (Sc), niobium (Nb), neodymium (Nd), lanthanum (La), cerium (Ce), silicon (Si), chromium (Cr), gallium (Ga), barium (Ba), actinium (Ac), calcium (Ca), boron (B), arsenic (As), hafnium (Hf), Molybdenum (Mo), rhenium (Re), ruthenium (Ru), rhodium (Rh), platinum (Pt), osmium (Os), iridium (Ir), gold (Au), and combinations thereof can also be obtained.

Additional examples of the lithium-containing battery material collected from at least one collector (e.g. 314A, 314B, 314C, 314D, 314E, 314F) include but are not limited to, ceramic solid-state electrolyte material, garnet-type solid-state oxide electrolyte materials, lithium lanthanum zirconium oxide material, Li₆ALa₃Ta₂O₁₂ (A=Sr, Ba), NASICON (NaM2(PO4)3 M=Ge, Ti, Zr), LLTO Perovskite-Type Structure Electrolytes synthesis and transport properties of two-dimensional LixM1/3Nb1-xTixO3 (M=La, Nd) perovskite (ABO3)-type oxides, Li superionic conductor (LISICON)-type structure oxide electrolytes, lithium phosphorous-oxynitride (LiPON)), solid-state sulfide electrolyte materials, such as Argyrodit Electrolyte, lithium phosphorus sulfide (Li₃PS₄, LPS) electrolyte, Li₇P₃S₁₁, Li7P2S8, Li11-xM2-xP1+xS12 (M=Ge, Sn, Si) (LGPS)-Type Structures: LGPS, Li₇La₃Zr₂O₁₂, Li₇La₃Zr₂O₁₂ doped with one or more metals, Li_{6.75}La₃Zr_{1.75}Ta_{0.25}O₁₂, Li_{6.5}La₃Zr₂Al_{0.25}O₁₂, Li_{6.5}La₃Zr₂Al_{0.24}O₁₂, Li_{6.5}La₃Zr₂Al_{0.22}O₁₂, Li_{6.76}La_{2.87}Zr_{2.0}Al_{0.24}O_{12.35}, Li_{6.74}La_{2.96}Zr_{2.0}Al_{0.25}O_{12.45}, Li_{6.27}La_{3.22}Zr_{2.0}Al_{0.3}O_{12.39}, Li_{6.4}La_{2.86}Zr_{2.0}Al_{0.24}O_{11.98}, Li_{6.43}La_{2.93}Zr_{2.0}Al_{0.24}O_{12.08}, Li_{6.32}La_{3.2}Zr_{2.0}Al_{0.46}O_{12.9}, Li_{6.57}La_{2.99}Zr_{2.0}Al_{0.22}O_{12.22}, Li_{6.4}La₃Zr₂Al_{0.2}O₁₂, Li_{6.54}La_{2.82}Zr_{2.0}Al_{0.24}O_{12.08}, Li_{6.49}La_{3.28}Zr_{2.0}Al_{0.31}O_{12.7}, Li_{6.28}La₃Zr₂Al_{0.24}O₁₂, Li_{6.25}La_{3.01}Zr_{2.0}Al_{0.22}O_{11.92}, Li_{6.49}La_{3.02}Zr_{2.0}Al_{0.23}O_{12.2}, Li_{6.5}La₃Zr_{1.5}Ta_{0.5}O₁₂, Li_{6.15}La₃Zr_{1.75}Ta_{0.25}Al_{0.2}O₁₂, Li_{6.25}La₃Zr₂Al_{0.25}O₁₂, Li_{6.15}La₃Zr_{1.75}Ta_{0.25}Ga_{0.2}O₁₂, Li_{6.25}La₃Zr₂Ta_{0.25}Ga_{0.2}O₁₂, Li_{6.4}La₃Zr₂Ga_{0.2}O₁₂, Li_{6.4}La₃Zr_{1.4}Ta_{0.6}O₁₂, Li₅La₃Nb₂O₁₂, Li₅La₃Ta₂O₁₂, Li₅La₃Ti₂O₁₂, Li₆La₃Sr₁Ta₂O₁₂, Li₆La₃Ba₁Ta₂O₁₂, Li₆La₃Ba₁Ti₂O₁₂, Li_{1.26}La_{2.24}Ti₄O₁₂, Li_{1.36}La_{2.24}Ti₄O₁₂, Li_{1.72}La_{2.24}Ti_{3.8}Ge_{0.2}O₁₂, Li_{1.72}La_{2.24}Ti_{3.8}Ge_{0.2}O₁₂, Li_{1.36}La_{2.24}Ti₄O₁₂, Li_{1.72}La_{2,24}Ti_{3.8}Ge_{0.2}O₁₂, Li_{1.72}La_{2,24}Ti_{3.8}Ge_{0.2}O₁₂, Li_{1.36}La_{2.24}Ti₄O₁₂, Li_{1.72}La_{2.24}Ti_{3.8}Ge_{0.2}O₁₂, Li_{1.72}La_{2.24}Ti_{3.8}Ge_{0.2}O₁₂, Li_{6.25}La₃Zr₂Ta_{0.25} Ga_{0.2}O₁₂, a ceramic material having a chemical composition of Liₐ La_{b} Zr_{c} Al_{d} D1ₑ . . . DNₙ Oᵥ, wherein 6.2≤a≤7.2, 2.8≤b≤3.5, 1.2≤c≤2.2, 2.0≤v≤12, and wherein at least one of D₁, . . . , D_{N} is a metal, N≥0, 0≤d≤0.8, 0≤e≤0.8, and 0≤n≤0.8, wherein D₁, D₂, . . . , D_{N} is selected from the group consisting of Al, Ta, Ti, Ge, Mg, Mn, Zr, Zn, Nb, Ce, Sn, Ga, Ba, Ac, Ca, Sc, V, Cr, Fe, Cu, B, As, Hf, Mo, W, Re, Ru, Rh, Pt, Ag, Os, Ir, Au, F, Cl, I, Br, a ceramic material having a chemical composition of Liₐ La_{b} Zr_{c} D1_{d} D2ₑ . . . DNₙ Oᵥ, wherein 6.2≤a≤7.2, 2.8≤b≤3.5, 1.2≤c≤2.2, 2.0≤v≤12, and wherein at least one of D₁, D₂, . . . , D_{N} is a metal, N≥0, 0≤d≤0.8, 0≤e≤0.8, and 0≤n≤0.8, wherein D₁, D₂, . . . , D_{N} is selected from the group consisting of Al, Ta, Ti, Ge, Mg, Mn, Zr, Zn, Nb, Ce, Sn, Ga, Ba, Ac, Ca, Sc, V, Cr, Fe, Cu, B, As, Hf, Mo, W, Re, Ru, Rh, Pt, Ag, Os, Ir, Au, F, Cl, I, Br, and combinations thereof. For example, the solid-state electrolyte material may be Liₐ La_{b} D1_{c} D2_{d} . . . DNₙ Oᵥ, where 4.5≤a≤7.2, 2.8≤b≤3.5, 1.5≤c≤2.5, 0≤d≤1.2, 0≤n≤1.2, and 2≤v≤12, and at least one of D₁, D₂, . . . , D_{N} is a metal, and N≥1. As another example, the solid-state electrolyte material may be Li₅La₃Nb₂O₁₂, Li₅La₃Ta₂O₁₂, Li₅La₃Ti₂O₁₂, Li₆La₃Sr₁Ta₂O₁₂, Li₆La₃Ba₁Ta₂O₁₂, Li₆La₃Ba₁Ti₂O₁₂, Li_{1.26}La_{2.21}Ti₄O₁₂. In another example, the chemical composition of the solid-state electrolyte material is Liₐ Al_{b} P_{c} D1_{d} . . . DNₙ Oᵥ, wherein 1≤a≤2, 0.2≤b≤1.5, 1.0≤c≤3.5, 0≤d≤2.0, 0≤n≤2.0, and 0.2≤v≤12, and wherein at least one of D₁, D₂, . . . , D_{N} is a metal, and N≥1; for example, and Li_{1.5}Al_{0.5}Ti_{1.5}P₃O₁₂, Li_{1.5}Al_{0.5}Ge_{1.5}P₃O₁₂. As still another example, the chemical composition of the solid-state electrolyte material may be Liₐ P_{b} S_{c} D1_{d} . . . DNₙ Xᵥ, where 5≤a≤16, 0.5≤b≤4.5, 3≤c≤16, 0≤d≤1.5, 0≤n≤1.5, 0≤v≤4, and at least one of D₁, D₂, . . . , D_{N} is a metal, N≥0, and X is a halogen; for example, Li₇P₃S₁₁, Li₃P₁S₄, Li₆P₁S₅Cl, Li₆P₁S₅Br₁, Li₆P₁S₅I, Li₆P₁S₅F₁, Li₇P₂S₈I₁, Li₇P₂S₈Br₁, Li₇P₂S₈Cl₁, Li₇P₂S₈F₁, Li₁₅P₄S₁₆Cl₃, Li_{14.8} Mg_{0.1}P₄S₁₆Cl₃, Li_{9.54}Si_{1.74}P_{1.44}S_{11.7}Cl_{0.3}, Li₁₀Ge₁P₂S₁₂, Li₁₀Si₁P₂S₁₂, Li₁₀Sn₁P₂S₁₂, Li₁₀Si_{0.3}Sn_{0.7}P₂S₁₂, Li₁₀Al_{0.3}Sn_{0.7}P₂S₁₂, Li₁₁Al₁P₂S₁₂. In another embodiment, the solid-state electrolyte material is Liₐ Ge_{b} P_{c} D1_{d} . . . DNₙ Oᵥ, where 10≤a≤13, 0.1≤b≤2.0, 0.1≤c≤1.5, 0.1≤d≤2.0, 0.1≤n≤2.0, 2≤v≤12, and at least one of D₁, D₂, . . . , D_{N} is a metal, N≥0, N≥0; for example, Li₁₂Ge_{0.5}Al_{1.0}Si_{0.55}P_{1.0}O₁₂, Li_{10.59}Ge_{1.58}V_{0.9}P_{0.53}O₁₂.

As another example, the lithium-containing battery material collected from at least one collector (e.g. 314A, 314B, 314C, 314D, 314E, 314F) may be in solid or semi-solid form, such as in powders or solid particles.

As shown in FIG. 1 and FIG. 3A, after step 120, a leachate solution 238 is obtained in the leachate solution step 130. In general, the leachate solution 238 comprises lithium ions, one or more non-lithium metal ions, and sulfate ions. At this step, the type of non-lithium metal ions existing in the leachate solution 238 depend on what type of lithium-containing battery material 220 is added. In the embodiment suggested in FIG. 3A and FIG. 3B, these metal ions are represented by, but not limited to, Lithium Ion (Li⁺) 234 and one or more non-lithium metal ion 236. Specifically, the non-lithium metal ion 236 used here is, but is not limited to, Cobalt Ion (Co²⁺).

In other embodiments, the non-lithium metal ion 236 can be ions other than cobalt ions. Exemplary non-lithium metal ions 236 include, but are not limited to, nickel ions, manganese ions, aluminum ions, magnesium ions, lanthanum ions, zirconium ions, strontium ions, barium ions, sodium ions, germanium ions, titanium ions, neodymium ions, silicon ions, tin ions, tantalum ions, zinc ions, niobium ions, cerium ions, gallium ions, actinium ions, calcium ions, scandium ions, vanadium ions, chromium ions, iron ions, copper ions, boron ions, arsenic ions, hafnium ions, molybdenum ions, tungsten ions, rhenium ions, ruthenium ions, rhodium ions, platinum ions, silver ions, osmium ions, iridium ions, gold ions, fluorine ions and combinations thereof.

After step 130, there are further steps that can be performed to enhance the quality of the leachate solution 238. Firstly, proceed to step 140. After adding the lithium-containing battery material 220 into the leaching solution 230, the leaching solution 230 and the lithium-containing battery material 220 can be heated together such that the lithium-containing battery material 220 can be fully dissolved in the leaching solution 230. To clarify, step 140 is performed before adding metal hydroxide (Me(OH)ₓ) in step 160.

After step 140, another extra step that is optional is step 150. After the leachate solution 238 is obtained in step 130, heated in step 140, one can further purify the leachate solution 238 as step 150. Specifically, during step 150, the leachate solution 238 is purified to remove undissolved impurity substances from the leachate solution 238. In one embodiment, a common way for such purification is through filtering, but it is not limited thereto. In another embodiment, the purifying method can be done from a technique selected from the group consisting of centrifuging, filtration, size-exclusion, chromatography, and the combination thereof.

As shown in FIG. 3A and FIG. 3B, after step 140 and step 150, metal hydroxide (Me(OH)ₓ) 252 is added to the leachate solution 238. This is step 160. The purpose of adding metal hydroxide is to precipitate the sulfate 232 in the leachate solution 238 so as to further purify the components of the leachate solution 238.

The metal hydroxide is selected from the group consisting of barium hydroxide (Ba(OH)₂), lead hydroxide (Pb(OH)₂), calcium hydroxide (Ca(OH)₂), strontium hydroxide (Sr(OH)₂), and the combination thereof. In an embodiment, barium hydroxide is selected to be added to the leachate solution 238, but it is not limited thereto.

As shown in FIG. 3B, in one embodiment, the barium hydroxide 252 is in solid form, but it is not limited thereto.

Since adding barium hydroxide 252 would potentially cause the precipitation of the metal ions (e.g. lithium ion 234 and non-lithium metal ion in FIG. 3A and FIG. 3B), step 170 is performed along with step 160 to prevent the precipitation of metal ions from happening.

Specifically, step 170 is to titrate the leachate solution 238 with an aqueous acid solution 250, therefore the leachate solution 238 can be maintained at a pH 7.0 or less, such as at pH 6.8 or less, such as at pH 6.5 or less, such as at pH 6.2 or less, such as at pH 6.0 or less, such as at pH 5.8 or less, such as at pH 5.5 or less, such as at pH 5.2 or less, such as at pH 5.0 or less, such as at pH 4.8 or less, such as at pH 4.5 or less, such as at pH 4.3 or less, such as at pH 4.0 or less, such as at pH 3.8 or less, such as at pH 3.6 or less, such as at pH 3.5 or less, such as at pH 3.2 or less, such as at pH 3.0 or less, such as at pH 2.8 or less, such as at pH 2.5 or less, such as at pH 2.3 or less, such as at pH 2.0 or less. This step can prevent the metal ions from precipitating, and also obtain a precipitate comprising precipitate (BaSO₄) 256 in the precipitation step 180.

Specifically, in one embodiment, the aqueous acid solution 250 is selected from the group consisting of acetic acid (CH₃COOH), nitric acid (HNO₃), oxalic acid (C₂H₂O₄), citric acid (CHO), malic acid (CHO), ascorbic acid, lactic acid (CHO), formic acid (CH₂O₂), uric acid (C₅H₄N₄O₃), tartaric acid (C₄H₆O₆), phosphoric acid (H₃PO₄), hydrochloric acid (HCl), sulfuric acid (H₂SO₄), hydrofluoric acid (HF), carbonic acid (H₂CO₃), hydrobromic acid (HBr), hydroiodic acid (HI), perchloric acid (HClO₄), formic acid (HCOOH), butyric acid (CH₃CH₂CH₂COOH), oxalic acid (H₂C₂O₄), lactic acid (CH₃CH(OH)COOH), benzoic acid (C₆H₅COOH), maleic acid (HO₂CCH═CHCO₂H), succinic acid (HOOCCH₂CH₂COOH), sulfurous acid (H₂SO₃), boric acid (H₃BO₃), acetylsalicylic acid (aspirin, C₉H₈O₄), chromic acid (H₂CrO₄), hydrocyanic acid (HCN), hydrogen sulfide (H₂S), hydrosulfuric acid (H₂SO₂), and combinations thereof. As shown in FIG. 3B and FIG. 3C, after step 160 and step 170, precipitate 256 can start to form. In one embodiment, the precipitate 256 is barium sulfate (BaSO₄) since the material added to precipitate sulfate 232 is barium hydroxide 252. However, the precipitate 256 is not limited thereto, and can be changed.

After obtaining the precipitate 256 at step 180, the precipitate 256 is further removed from the leachate solution 238. This is step 190. The separation of precipitate 256 from the leachate solution 238 is performed by a technique selected from the group consisting of centrifuging, filtration, size-exclusion chromatography, and the combination thereof.

The collected precipitate 256 is stored in a precipitate container 262. As shown in FIG. 3C, in one embodiment, the precipitate 256 is barium sulfate (BaSO₄). In this embodiment, the collected barium sulfate can be repackaged and resold as a lubricant for oil drilling process or for other desired purposes.

About 80% of the world's barium sulfate production is consumed as a component of oil well drilling fluid. In other words, the embodiment of using barium hydroxide in the recovering process is not only useful in the sense that it can keep all the desired metal components in a soluble form, but also that the barium sulfate can have its own value as a byproduct.

See FIG. 3B and FIG. 3C, after the completion of step 190, a metal-containing organic and/or inorganic salt solution 258 is further filtered through a filtering device 260. After filtration, the remaining solution is the metal-containing organic and/or inorganic salt solution 258.

The result of method 100 is a high level of lithium, cobalt, nickel, and other valuable metal reclaiming, recovery and recycling, in the form of leachate solution 238. Besides, method 100 can also be used to process various cathode material to obtain metal-containing compounds, and is not just limited to obtaining one specific compound.

In the embodiment demonstrated in FIG. 3B and FIG. 3C, the metal-containing organic and/or inorganic solution 258 contains metal ions including lithium ion 234 and non-lithium metal ion (here, Co²⁺), along with acetate 254. The existence of acetate 254 is the result of using acetic acid as the aqueous acid solution 250, but it is not limited thereto. In other embodiment, the metal ions and the corresponding acid ions can be different according to the lithium-containing battery material 220 and aqueous acid solution 250 used in the method 100.

In one embodiment, the metal-containing organic and/or inorganic salt solution 258 comprises a lithium-containing salt selected from the group consisting of lithium acetate (LiCH₃COO), lithium nitrate (LiNO₃), lithium citrate (Li₃C₆H₅O₇), lithium oxalate (Li₂C₂O₄), lithium malate (Li₂C₄H₄O₅), lithium ascorbate, lithium lactate (CH₃CH(OH)COOLi), lithium formate (LiCHO₂), lithium urate (LiC₅H₃N₄O₃), lithium tartrate (Li₂C₄H₄O₆), lithium sulfate (Li₂SO₄), lithium carbonate (Li₂CO₃), lithium hydroxide (LiOH), lithium chloride (LiCl), and the combinations thereof.

In another embodiment, on top of the compounds listed above, the metal-containing organic and/or inorganic salt solution 258 further comprises a metal salt selected from the group consisting of cobalt acetate (C₄H₆CoO₄), cobalt nitrate (Co(NO₃)₂), cobalt oxalate (CoC₂H₄), nickel acetate (C₄H₆NiO₄), nickel malate, nickel oxalate, manganese acetate (C₄H₆MnO₄), manganese malate, manganese oxalate (C₂MnO₄), aluminum acetate, aluminum malate, aluminum oxalate, magnesium acetate, magnesium malate, magnesium oxalate, lanthanum acetate, lanthanum malate, lanthanum oxalate, and combinations thereof.

To summarize, please refer to FIG. 3A, FIG. 3B, and FIG. 3C. The metal-containing organic and/or inorganic salt solution 258 is obtained from method 100, which comprises:

First, obtaining a processed leachate solution from a process comprising leaching a solution. The solution comprises a lithium-containing battery material 220, sulfuric acid (in the form of sulfate 232 and hydrogen ion H⁺), and water.

Second, barium hydroxide 252 is added to the leachate solution 238. The leachate solution 238 is also titrated with an aqueous acid solution 250 during the adding of metal hydroxide (in an embodiment, barium hydroxide 252) so as to maintain at a pH 7.0 or less, such as at pH 6.8 or less, such as at pH 6.5 or less, such as at pH 6.2 or less, such as at pH 6.0 or less, such as at pH 5.8 or less, such as at pH 5.5 or less, such as at pH 5.2 or less, such as at pH 5.0 or less, such as at pH 4.8 or less, such as at pH 4.5 or less, such as at pH 4.3 or less, such as at pH 4.0 or less, such as at pH 3.8 or less, such as at pH 3.6 or less, such as at pH 3.5 or less, such as at pH 3.2 or less, such as at pH 3.0 or less, such as at pH 2.8 or less, such as at pH 2.5 or less, such as at pH 2.3 or less, such as at pH 2.0 or less.

Third, a precipitate 256 is obtained and further removed from the leachate solution 238. The remaining solution is the metal-containing organic and/or inorganic salt solution 258.

The metal-containing organic and/or inorganic salt solution 258 can be used in two main ways. First, it can be used directly back in the manufacturing of lithium-containing battery material. This is efficient compared to the currently existing methods because the raw material—metals, are already dissolved in the leachate solution 238 without the need of further processing.

Second, the metal-containing organic and/or inorganic salt solution 258 can also be further processed to separate the lithium ion 234 or non-lithium metal ion so as to recover these high value metals independently. Since all of the valuable metals are kept in the soluble form, it is easy to separate each of the metal one by one, so the collection method is easy to perform.

Specifically, the metal salts obtained are selected from the group consisting of lithium salts, cobalt salts, nickel salts, aluminum salts, manganese salts, magnesium salts, lanthanum salts, zirconium salts, strontium salts, barium salts, sodium salts, germanium salts, titanium salts, neodymium salts, silicon salts, tin salts, tantalum salts, zinc salts, niobium salts, cerium salts, gallium salts, actinium salts, calcium salts, scandium salts, vanadium salts, chromium salts, iron salts, copper salts, boron salts, arsenic salts, hafnium salts, molybdenum salts, tungsten salts, rhenium salts, ruthenium salts, rhodium salts, platinum salts, silver salts, osmium salts, iridium salts, gold salts, fluorine salts, and combinations thereof.

As for the process performed to collect these metal salts, it is a process selected from a group consisting of chemical precipitation, solvent extraction, electrochemical deposition, electrochemical plating, and combinations thereof.

As shown in FIG. 3A, FIG. 3B, and FIG. 3C, to properly perform method 100, apparatus 200 for recovering a metal-containing organic and/or inorganic salt solution from a lithium-containing battery material comprises the leaching container 210, a mixing tool 212, a separator 260, and a collector.

In one embodiment, the leaching container 210 can be a mixer, and the mixing tool 212 is positioned inside the leaching container 210 to properly mix the lithium-containing battery material 220, the leaching solution 230, and the rest. In one embodiment, the separator 260 is a filtering device. The techniques performed by the separator 260 can include, but is not limited to, membrane filtration, centrifugal filtration, gravity filtration, and vacuum filtration. The precipitate 256 can be collected in the precipitate container 262 through the separator 260.

Referring back to FIG. 2, the recovering apparatus 200 (shown as 200A, 200B, 200C, 200D, 200E, and 200F) also includes their corresponding collectors respectively (314A, 314B, 314C, 314D, 314E, 314F). The collectors are then further connected to the system 300. The entire system works in the most efficient manner when all of the above elements are present. By connecting the recovering apparatus 200 in multiple processing steps throughout the system 300, one can recover most of the lithium-containing battery material 220 back into the production line.

While the foregoing is directed to some illustrative embodiments of the present invention, other and further embodiments of the invention can be devised without departing from the basic scope described.

What is claimed is:

1. A method for recovering a metal-containing salt solution from a lithium-containing battery material comprising:
leaching the lithium-containing battery material by adding the lithium-containing battery material into a leaching solution comprising water and sulfuric acid (H₂SO₄);
obtaining a leachate solution after leaching by the leaching solution;
adding metal hydroxide (Me(OH)ₓ) to the leachate solution;
titrating the leachate solution with an aqueous acid solution to maintain the leachate solution to be at a pH 7.0 or less and obtaining a precipitate comprising metal sulfate (Me_{y}SO₄); and separating solid forms of metal sulfate (Me_{y}SO₄) from the leachate solution and acquiring the metal-containing salt solution.

2. The method of claim 1, wherein the leaching solution further comprises a reducing agent added to speed up the leaching of the lithium-containing battery material in the leaching solution.

3. The method of claim 2, wherein the reducing agent is selected from the group consisting of hydrogen peroxide, sodium hydrogen sulfite, sodium bisulfite, glucose, sucrose, and combinations thereof.

4. The method of claim 1, wherein the metal hydroxide is selected from the group consisting of barium hydroxide, lead hydroxide, calcium hydroxide, strontium hydroxide, and combinations thereof.

5. The method of claim 1, wherein the leachate solution comprises lithium ions, one or more non-lithium metal ions, and sulfate ions.

6. The method of claim 5, wherein the one or more non-lithium metal ions comprises metal ions selected from the group consisting of cobalt ions, nickel ions, manganese ions, aluminum ions, magnesium ions, lanthanum ions, zirconium ions, strontium ions, barium ions, sodium ions, germanium ions, titanium ions, neodymium ions, silicon ions, tin ions, tantalum ions, zinc ions, niobium ions, cerium ions, gallium ions, actinium ions, calcium ions, scandium ions, vanadium ions, chromium ions, iron ions, copper ions, boron ions, arsenic ions, hafnium ions, molybdenum ions, tungsten ions, rhenium ions, ruthenium ions, rhodium ions, platinum ions, silver ions, osmium ions, iridium ions, gold ions, fluorine ions and combinations thereof.

7. The method of claim 1, wherein the lithium-containing battery material is selected from the group consisting of lithium cobalt oxide, lithium nickel oxide, lithium manganese oxide, lithium nickel manganese cobalt oxide, lithium nickel cobalt aluminum oxide, lithium nickel cobalt manganese aluminum oxide, lithium nickel magnesium cobalt oxide, lithium iron phosphate, Lithium lanthanum zirconium oxide (LLZO), and combinations thereof.

8. The method of claim 1, wherein the aqueous acid solution is selected from the group consisting of acetic acid, nitric acid, oxalic acid, citric acid, malic acid, ascorbic acid, lactic acid, formic acid, uric acid, tartaric acid, and combinations thereof.

9. The method of claim 1, wherein the metal-containing salt solution comprises a lithium-containing salt selected from the group consisting of lithium acetate (C₂H₃LiO₂), lithium nitrate, lithium citrate (Li₃C₆H₅O7), lithium oxalate, lithium citrate, lithium malate, lithium ascorbate, lithium lactate (CH₃CHCOOLi), lithium formate (CHLiO₂), lithium urate, lithium tartrate, and combinations thereof.

10. The method of claim 9, wherein the metal-containing salt solution further comprises a metal salt selected from the group consisting of cobalt acetate, cobalt nitrate, cobalt oxalate, nickel acetate, nickel malate, nickel oxalate, manganese acetate, manganese malate, manganese oxalate, aluminum acetate, aluminum malate, aluminum oxalate, magnesium acetate, magnesium malate, magnesium oxalate, lanthanum acetate, lanthanum malate, lanthanum oxalate, and combinations thereof.

11. The method of claim 1, further comprising:
acquiring one or more metal salts from the metal-containing salt solution, wherein the metal salts are selected from the group consisting of lithium salts, cobalt salts, nickel salts, aluminum salts, manganese salts, magnesium salts, lanthanum salts, zirconium salts, strontium salts, barium salts, sodium salts, germanium salts, titanium salts, neodymium salts, silicon salts, tin salts, tantalum salts, zinc salts, niobium salts, cerium salts, gallium salts, actinium salts, calcium salts, scandium salts, vanadium salts, chromium salts, iron salts, copper salts, boron salts, arsenic salts, hafnium salts, molybdenum salts, tungsten salts, rhenium salts, ruthenium salts, rhodium salts, platinum salts, silver salts, osmium salts, iridium salts, gold salts, fluorine salts, and combinations thereof.

12. The method of claim 1, wherein the obtaining is performed by a process selected from a group consisting of chemical precipitation, solvent extraction, electrochemical deposition, electrochemical plating, and combinations thereof.

13. The method of claim 1, further comprising:
heating the leachate solution prior to adding the metal hydroxide (Me(OH)ₓ) such that the lithium-containing battery material is fully dissolved in the leaching solution.

14. The method of claim 1, further comprising:
purifying the leachate solution to remove undissolved impurity substances from the leachate solution using a technique selected from the group consisting of centrifuging, filtration, size-exclusion chromatography, and the combination thereof.

15. The method of claim 1, wherein the separating solid forms of metal sulfate (Me_{y}SO₄) is performed by a technique selected from the group consisting of centrifuging, filtration, size-exclusion chromatography, and the combination thereof.

16. A processing system for recovering a metal-containing salt solution from a lithium-containing battery material comprising:
a first reaction chamber having a liquid mixer and a chamber outlet;
a first gas-solid separator having a first separator outlet and a second separator outlet;
a second reaction chamber connected to a product collector; and
one or more recovering apparatuses, wherein each recovering apparatus comprising:
at least one collector to collect solids of the lithium-containing battery material from the processing system, wherein the at least one collector is connected to an outlet within the processing system, and the outlet is selected from the group consisting of the chamber outlet, the first separator outlet, the second separator outlet, the product collector, and combinations thereof; and
at least one leaching container connected to the at least one collector, wherein the at least one leaching container contains therein a leaching solution comprising water and sulfuric acid (H₂SO₄).

17. The processing system of claim 16, wherein the processing system further comprises a second gas-solid separator having a third separator outlet and a fourth separator outlet, and wherein at least one collector is connected to another outlet selected from the group consisting of the third separator outlet, the fourth separator outlet, and combinations thereof.

18. The processing system of claim 16, wherein the first reaction chamber is connected to a mist generator adapted to generate a mist from a liquid mixture comprising a lithium-containing solution.

19. The processing system of claim 16, wherein each recovering apparatus further comprises a mixing tool.

20. The processing system of claim 16, wherein each recovering apparatus further comprises a separator.

21. A processing system for recovering a metal-containing salt solution from a lithium-containing battery material comprising:
a first reaction chamber having a liquid mixer and a chamber outlet;
a first gas-solid separator having a first separator outlet and a second separator outlet;
a second reaction chamber connected to a product collector;
a second gas-solid separator having a third separator outlet and a fourth separator outlet; and
one or more recovering apparatuses, wherein each recovering apparatus, comprising:
at least one collector to collect solids of the lithium-containing battery material from the processing system, wherein the at least one collector is connected to an outlet within the processing system, and the outlet is selected from the group consisting of the chamber outlet, the product collector, the first separator outlet, the second separator outlet, the third separator outlet, the fourth separator outlet, and combinations thereof;
at least one leaching container connected to the at least one collector, wherein the at least one leaching container contains therein a leaching solution comprising water and sulfuric acid (H₂SO₄).
